(19) United States
(12) Patent Application Publication
(10) Pub. No.: US 2021/0095183 A1
(43) Pub. Date: Apr. 1, 2021

(54) ADDITIVES FOR POLYMER EMULSION STABILIZATION

(71) Applicant: ChampionX USA Inc., Sugar Land, TX (US)

(72) Inventors: Xiaojin Harry Li, Palatine, IL (US); Tri T. Phan, Sugar Land, TX (US); Tzu-Ping Hsu, Richmond, TX (US); Kerry O'Connell, Downers Grove, IL (US); Michael Cash, Richmond, TX (US)

(21) Appl. No.: 17/039,429

(22) Filed: Sep. 30, 2020

Related U.S. Application Data
(60) Provisional application No. 62/908,258, filed on Sep. 30, 2019.

(51) Int. Cl. C09K 8/588; C09K 8/584; E21B 41/00

(52) U.S. Cl. CPC C09K 8/588; C09K 2208/28; E21B 41/0007; C09K 8/584

(57) ABSTRACT

A polymer composition has been developed that provides low viscosity oil-in-water polymer emulsions that are stable to shear conditions and are storage stable at low temperature conditions (e.g., −6.7° C. or less) or higher temperature conditions (e.g., up to 60° C.). Use of particular additives provides stability to the emulsion and imparts advantageous properties when the polymer composition is contacted with a hydrocarbon fluid. These compositions are particularly useful as drag reducers for delivery to a subsea flowline via an umbilical line.

### CROSS REFERENCE TO RELATED APPLICATIONS

This application claims priority to U.S. Provisional Patent Application Ser. No. 62/908,258 filed on Sep. 30, 2019, the disclosure of which is incorporated herein by reference in its entirety.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable

### REFERENCE TO A SEQUENCE LISTING, TABLE, OR COMPUTER PROGRAM LISTING APPENDIX SUBMITTED ON A COMPACT DISC AND AN INCORPORATION-BY-REFERENCE OF THE MATERIAL ON A COMPACT DISC

Not applicable.

### FIELD OF THE INVENTION

A polymer composition has been developed that provides low viscosity oil-in-water polymer emulsions that are stable to shear conditions and are storage stable at low temperature conditions (e.g., −6.7° C. or less) or higher temperature conditions (e.g., up to 60° C.). Use of particular additives provides stability to the emulsion and imparts advantageous properties when the polymer composition is contacted with a hydrocarbon fluid. These compositions are particularly useful as drag reducers for delivery to a subsea flowline via an umbilical line.

### BACKGROUND OF THE INVENTION

In the subsea production of oil and gas, production piping typically presents a significant bottleneck because of the difficulty and expense associated with the subsea installation of the piping. The production decrease caused by bottle-necking at subsea flowlines can have severe economic ramifications due to the resulting inability to run the hydrocarbon production system at full capacity. Preventing or reducing bottlenecking at subsea flowlines can be affected by increasing the diameter of the flowlines, increasing the number of flowlines, or reducing the amount of friction loss in the flowlines to allow more flow through the same diameter lines. Because of the expense of increasing the size or number of flowlines, it is advantageous to reduce friction losses in subsea flowlines.

It is commonly known that a variety of drag reducers are available for reducing the friction loss of a fluid being transported through a conduit in a turbulent flow regime. Ultra-high molecular weight polymers are known to function well as drag reducers; however, drag reducers vary in their effectiveness. Traditionally, the more effective drag reducing additives have been those containing higher molecular weight polymers. Increasing the molecular weight of the polymer generally increases the percent drag reduction obtained, with the limitation that the polymer must be capable of dissolving in the liquid in which friction loss is affected.

Many offshore oil and gas production facilities are operated from remote locations that can be miles away from the production wells. When remote facilities are used to operate a subsea production facility, an umbilical line can be used to provide power and various flow assurance chemicals to the production facility. These umbilical lines can have many relatively small diameter injection lines where various chemicals can be injected into the flowline at a point near the production wells. These chemicals generally include low viscosity fluids such as hydrate inhibitors, wax inhibitors, and corrosion inhibitors that can help to improve flow conditions in the flowline.

With the constraints of a relatively low viscosity (e.g., less than 500 centipoise) and small particle sizes (e.g., less than 5 microns), a need still exists for effective drag reducers that do not block or plug umbilical lines in the subsea production system.

### BRIEF SUMMARY OF THE INVENTION

This disclosure is directed to a polymer composition comprising an oil-in-water emulsion, which comprises an aqueous phase comprising water and an oil phase comprising an oil-soluble polymer, an oil-miscible polymer, or a emulsifiable polymer, and an additive, wherein the additive comprises a polyglycerol, a polyglycerol derivative, a surfactant having a hydrophilic-lipophilic balance (HLB) of equal to or greater than about 8, or a combination thereof.

Preferably, the polymer composition contains an additive wherein the additive comprises a polyglycerol or a polyglycerol derivative.

The polyglycerol derivative of the polymer compositions discloses herein comprises a linear alkyl group, a branched alkyl group, a linear alkenyl group, a branched alkenyl group, an anionic, a cationic, or a zwitterionic derivative thereof, or a combination thereof.

The polyglycerol or polyglycerol derivative of the polymer compositions comprises moieties having a linear structure, a branched structure, a hyperbranched structure, a dendritic structure, a cyclic structure, or a combination thereof.

The polyglycerol of the polymer compositions comprises a lactate salt, a sulfate salt, or a combination thereof.

The polyglycerol or polyglycerol derivative has a weight average molecular weight of from about 150 to about 1,000,000 Daltons.

The surfactant having a HLB of equal to or greater than about 8 of the polymer compositions described herein comprises a sulfur-containing surfactant.

The sulfur-containing surfactant of the polymer compositions comprises an alkyl sulfate, an alkanol oxyalkylated sulfate, an alkylphenol oxyalkylated sulfate, an alkyl sulfonate, an alkanol oxyalkylated sulfonate, an alkylphenol oxyalkylated sulfonate, an alkyl sulfosuccinate, an alkanol oxyalkylated sulfosuccinate, an alkylphenol oxyalkylated sulfosuccinate, a sulfone, or a combination thereof.

Preferably, the alkyl sulfate can be a C₄ to C₃₀ alkyl sulfate, a C₆ to C₂₄ alkyl sulfate, or a C₈ to C₁₈ alkyl sulfate.

Preferably, the alkyl sulfosuccinate can be a C₄ to C₃₀ alkyl sulfosuccinate, C₆ to C₂₄ alkyl sulfosuccinate, or a as to C₁₈ alkyl sulfosuccinate.

The polymer composition described herein can further comprise a trialkyl amine or a trialkanol amine, a salt thereof, or a combination thereof.

The trialkyl amine or trialkanol amine can comprise C₁ to C₆ alkyl groups.

The trialkanol amine can comprise triethanol amine.

The oil-soluble polymer, the oil-miscible polymer, or the emulsifiable polymer of the polymer compositions described herein are derived from a monomer having a structure of Formula 1:

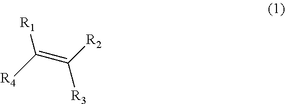

wherein R₁, R₃, and R₄ are independently hydrogen, alkyl, alkenyl, or aryl; R₂ is hydrogen, alkyl, alkenyl, aryl, —C(O)OR₅, or —C(O)NR₆R₇; and R₅, R₆, and R₇ are independently hydrogen, alkyl, alkenyl, or aryl.

The oil-soluble polymer, the oil-miscible polymer, or the emulsifiable polymer of the polymer compositions described herein are derived from a monomer having a structure of Formula 2:

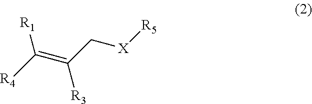

wherein R₁, R₃, and R₄ are independently hydrogen, alkyl, alkenyl, or aryl; X is —O— or —NR₆—; R₅ is hydrogen, alkyl, alkenyl, or aryl; and R₆ is hydrogen or alkyl.

For the monomers having a structure of Formula 1 or 2, R₁, R₃, and R₄ are independently hydrogen or C₁ to C₆ alkyl.

Monomers having a structure of Formula 1 or 2, can have R₁ and R₄ be hydrogen.

Monomers having a structure of Formula 1 or 2, can have R₃ be hydrogen or methyl.

Monomers having a structure of Formula 2, can have X be —O—.

Monomers having a structure of Formula 1 or 2, can have R₅ be C₁ to C₄₀ alkyl or C₁ to C₄₀ alkenyl.

Monomers having a structure of Formula 1 or 2, can have R₅ be 2-ethylhexyl.

The polymer compositions can have the weight average molecular weight of the oil-soluble polymer, the oil-miscible polymer, or the emulsifiable polymer be greater than about 1,000,000 Daltons as measured by gel permeation chromatography (GPC) against a polystyrene standard.

The polymer compositions can have the weight average molecular weight of the oil-soluble polymer, the oil-miscible polymer, or the emulsifiable polymer be from about 500 Daltons to about 50,000,000 Daltons or from about 5,000,000 Daltons to about 50,000,000 Daltons.

Further, the polymer compositions can have the bulk viscosity of the polymer composition be less than about 500 centipoise at a temperature of 22° C.

Additionally, the polymer composition described herein can have the oil-soluble polymer, the oil-miscible polymer, or the emulsifiable polymer have a concentration of from about 10 wt. % to about 70 wt. % in the polymer composition, based on the amount of the oil-soluble polymer, the oil-miscible polymer, or the emulsifiable polymer, additive, and water.

Also disclosed is a method of reducing drag resistance in a hydrocarbon fluid flowing in a fluid conduit. The method comprises injecting the polymer compositions disclosed herein into the conduit to contact the hydrocarbon fluid and thereby reduce the drag resistance of the hydrocarbon fluid in the conduit.

Also disclosed is a method of delivering the polymer compositions described herein to a hydrocarbon fluid recovered from a hydrocarbon-containing subterranean formation comprising transporting the polymer composition through a fluid conduit having a length of at least about 500 feet, wherein the viscosity of the polymer composition is less than 500 centipoise in the fluid conduit and the oil-soluble polymer, the oil-miscible polymer, or the emulsifiable polymer begins being released from the emulsion within 30 minutes of contacting the hydrocarbon fluid.

The viscosity of the polymer composition can be less than 100 centipoise in the fluid conduit and the oil-soluble polymer, the oil-miscible polymer, or the emulsifiable polymer can begin being released from the emulsion within 5 minutes of contacting the hydrocarbon fluid.

Also disclosed are methods of reducing the drag associated with transporting a hydrocarbon fluid through a subsea flowline comprising transporting the polymer compositions described herein through an umbilical line to the subsea flowline and contacting the polymer composition with the hydrocarbon fluid at an injection point.

The polymer compositions and methods described herein can have the oil-in-water emulsion invert to release at least 50% of the oil-soluble polymer, the oil-miscible polymer, or the emulsifiable polymer into a hydrocarbon fluid within 60 minutes after contacting the oil-in-water emulsion with the hydrocarbon fluid.

Additionally, the hydrocarbon fluid can further comprise an aqueous solution. For example, the hydrocarbon fluid can be part of a fluid in a hydrocarbon-containing subterranean formation that also contains an aqueous solution.

The hydrocarbon fluid that the oil-soluble polymer, the oil-miscible polymer, or the emulsifiable polymer is released into can comprise at least about 20 wt. % of hydrocarbon based on the total weight of the hydrocarbon fluid.

The polymer compositions or methods advantageously have the oil-in-water emulsion invert to release at least 80% or 95% of the oil-soluble polymer, the oil-miscible polymer, or the emulsifiable polymer into the hydrocarbon fluid.

The oil-soluble polymer, the oil-miscible polymer, or the emulsifiable polymer is released into the hydrocarbon fluid within 50, within 20, or within 5 minutes after contacting the oil-in-water emulsion with the hydrocarbon fluid.

The hydrocarbon fluid contacted with the polymer compositions described herein can be recovered from a subterranean hydrocarbon-containing reservoir.

The oil-in-water emulsion can invert to release the oil-soluble polymer, the oil-miscible polymer, or the emulsifiable polymer into the hydrocarbon fluid resulting in at least 5%, 25%, or 40% drag reduction of the hydrocarbon fluid flowing in a conduit within 15 minutes after contacting the oil-in-water emulsion with the hydrocarbon fluid.

The methods described herein can have the polymer composition further comprise a corrosion inhibitor, an organic solvent, an asphaltene inhibitor, a paraffin inhibitor, a scale inhibitor, an emulsifier, a water clarifier, a dispersant, an emulsion breaker, a reverse emulsion breaker, a gas hydrate inhibitor, a biocide, a pH modifier, a surfactant, or a combination thereof.

Other objects and features will be in part apparent and in part pointed out hereinafter.

### BRIEF DESCRIPTION OF THE SEVERAL VIEWS OF THE DRAWING

FIGS. 1A, 1B, 1C, 1D, 1E, and 1F show graphs of the percent pressure loss reduction or precent drag reduction versus time for polymer compositions Comp-1, Comp-6, Comp-10, Comp-16, Comp-21, and Comp-22, respectively, in neat form or a made down solution having various additives.

FIG. 2 is a schematic of a dynamic stability umbilical loop (DSUL) used to evaluate product stability under dynamic conditions.

FIG. 3 is a graph of the differential pressure measured between the inlet and outlet of the DSUL versus the time in days for Comp-1 ad Comp-6.

Corresponding reference characters indicate corresponding parts throughout the drawings.

### DETAILED DESCRIPTION OF THE INVENTION

Polymer compositions have been developed that provide low viscosity oil-in-water polymer emulsions that are stable to shear conditions and are storage stable at low temperature conditions (e.g., −6.7° C. or less) or higher temperature conditions (e.g., up to 60° C.). Use of particular additives provides stability to the emulsion and shear resistance when pumped through a subsea umbilical line.

The polymer compositions are stable upon transport and storage, such as in a fluid conduit (e.g. an umbilical line). Stated another way, the polymer compositions described herein comprise stable oil-in-water emulsions and the emulsions have advantageous properties such that the polymer compositions do not gel, develop a viscosity that is too high, or precipitate out of the injection fluid (e.g. do not plug the pump or umbilical line). After the polymer composition is contacted with the hydrocarbon fluid flowing in the conduit, the oil-soluble polymer, the oil-miscible polymer, or the emulsifiable polymer in the oil-in-water emulsion is released into the hydrocarbon fluid in a time sufficient to reduce drag resistance of the flowing hydrocarbon fluid.

This disclosure is directed to a polymer composition comprising an oil-in-water emulsion, which comprises an aqueous phase comprising water and an oil phase comprising an oil-soluble polymer, an oil-miscible polymer, or a emulsifiable polymer, and an additive, wherein the additive comprises a polyglycerol, a polyglycerol derivative, a surfactant having a hydrophilic-lipophilic balance (HLB) of equal to or greater than about 8, or a combination thereof.

Preferably, the polymer composition contains an additive wherein the additive comprises a polyglycerol or a polyglycerol derivative.

The polyglycerol derivative can comprise a polyglycerol alkyl ether, a polyglycerol alkyl ester, or a combination thereof.

The polyglycerol derivative of the polymer compositions discloses herein comprises a linear alkyl group, a branched alkyl group, a linear alkenyl group, a branched alkenyl group, an anionic, a cationic, or a zwitterionic derivative thereof, or a combination thereof.

The polyglycerol or polyglycerol derivative of the polymer compositions comprises moieties having a linear structure, a branched structure, a hyperbranched structure, a dendritic structure, a cyclic structure, or a combination thereof.

The polyglycerol of the polymer compositions comprises a lactate salt, a sulfate salt, or a combination thereof.

The polyglycerol or polyglycerol derivative has a weight average molecular weight of from about 150 to about 1,000,000 Daltons, from about 200 to about 1,000,000 Daltons, from about 150 to about 500,000 Daltons, from about 200 to about 500,000 Daltons, from about 150 to about 100,000 Daltons, from about 200 to about 100,000 Daltons, from about 150 to about 50,000 Daltons, from about 200 to about 50,000 Daltons, from about 150 to about 20,000 Daltons, from about 200 to about 20,000 Daltons, from about 150 to about 16,000 Daltons, from about 200 to about 16,000 Daltons, from about 400 to about 16,000 Daltons, from about 150 to about 5,000 Daltons, from about 200 to about 5,000 Daltons, from about 150 to about 4,000 Daltons, from about 200 to about 4,000 Daltons, from about 150 to about 500 Daltons, from about 200 to about 500 Daltons, from about 150 to about 400 Daltons, or from about 200 to about 400 Daltons as measured by gel permeation chromatography (GPC) against a polyethylene oxide (PEO)/polyethylene glycol (PEG) standard for polyglycerols and a polysaccharide standard for polyglycerol alkyl ethers or polyglycerol alkyl esters.

The polyglycerol or polyglycerol derivative also has a polydispersity of from about 1 to about 15, from about 1 to about 11, from about 1 to about 5, from about 1 to about 3, from about 1 to about 2.5, from about 1 to about 2, from about 1 to about 1.5, from about 1.2 to about 15, from about 1.2 to about 11, from about 1.2 to about 5, from about 1.2 to about 3, from about 1.2 to about 2.5, from about 1.2 to about 2, from about 1.2 to about 1.5, from about 1.4 to about 15, from about 1.4 to about 11, from about 1.4 to about 5, from about 1.4 to about 3, from about 1.4 to about 2.5, from about 1.4 to about 2, or from about 1.4 to about 1.5.

The surfactant having a HLB of equal to or greater than about 8 of the polymer compositions described herein comprises a sulfur-containing surfactant.

The sulfur-containing surfactant of the polymer compositions comprises an alkyl sulfate, an alkanol oxyalkylated sulfate, an alkylphenol oxyalkylated sulfate, an alkyl sulfonate, an alkanol oxyalkylated sulfonate, an alkylphenol oxyalkylated sulfonate, an alkyl sulfosuccinate, an alkanol oxyalkylated sulfosuccinate, an alkylphenol oxyalkylated sulfosuccinate, a sulfone, or a combination thereof.

The sulfone can be dimethyl sulfone, ethyl methyl sulfone, dibutyl sulfone, a butadiene sulfone, a dicyclopentyl sulfone, butyl cyclopentyl sulfone, cyclohexyl methyl sulfone, butyl cyclohexyl sulfone, methyl phenyl sulfone, dibenzyl sulfone, ditolyl sulfone, or a combination thereof.

The alkyl sulfate can be a C₂ to C₃₀ alkyl sulfate, a C₄ to C₃₀ alkyl sulfate, a C₆ to C₃₀ alkyl sulfate, a C₈ to C₃₀ alkyl sulfate, a C₁₀ to C₃₀ alkyl sulfate, a C₁₂ to C₃₀ alkyl sulfate, a C₂₀ to C₃₀ alkyl sulfate, C₂ to C₂₄ alkyl sulfate, a C₄ to C₂₄ alkyl sulfate, a C₆ to C₂₄ alkyl sulfate, a C₂₀ to C₂₄ alkyl sulfate, a C₁₀ to C₂₄ alkyl sulfate, a C₁₂ to C₂₄ alkyl sulfate, a C₂₀ to C₂₄ alkyl sulfate, a C₂ to C₂₀ alkyl sulfate, a 04 to 020 alkyl sulfate, a C₆ to C₂₀ alkyl sulfate, a C₈ to C₂₀ alkyl sulfate, a C₁₀ to C₂₀ alkyl sulfate, a C₁₂ to C₂₀ alkyl sulfate, a C₂ to C₁₈ alkyl sulfate, a C₄ to C₁₈ alkyl sulfate, a C₆ to C₁₈ alkyl sulfate, a C₈ to C₁₈ alkyl sulfate, a C₁₀ to C₁₈ alkyl sulfate, a C₁₂ to C₁₈ alkyl sulfate, a C₂ to C₁₆ alkyl sulfate, a C₄ to C₁₆ alkyl sulfate, a C₆ to C₁₆ alkyl sulfate, a C₈ to C₁₆ alkyl sulfate, a C₁₀ to C₁₆ alkyl sulfate, a C₁₂ to C₁₆ alkyl sulfate, or a combination thereof.

The alkyl sulfosuccinate can be a C₂ to C₃₀ alkyl sulfosuccinate, a C₄ to C₃₀ alkyl sulfosuccinate, a C₆ to C₃₀ alkyl sulfosuccinate, a C₈ to C₃₀ alkyl sulfosuccinate, a C₁₀ to C₃₀ alkyl sulfosuccinate, a C₁₂ to C₃₀ alkyl sulfosuccinate, a C₂₀ to C₃₀ alkyl sulfosuccinate, C₂ to C₂₄ alkyl sulfosuccinate, a C₄ to C₂₄ alkyl sulfosuccinate, a C₆ to C₂₄ alkyl sulfosuccinate, at C₈ to C₂₄ alkyl sulfosuccinate, a C₁₀ to C₂₄ alkyl sulfosuccinate, a C₁₂ to C₂₄ alkyl sulfosuccinate, a C₂₀ to C₂₄ alkyl sulfosuccinate, a C₂ to C₂₀ alkyl sulfosuccinate, a C₄ to C₂₀ alkyl sulfosuccinate, a C₆ to C₂₀ alkyl sulfosuccinate, a C₈ to C₂₀ alkyl sulfosuccinate, a C₁₀ to C₂₀ alkyl sulfosuccinate, a C₁₂ to C₂₀ alkyl sulfosuccinate, a C₂ to C₁₈ alkyl sulfosuccinate, a C₄ to C₁₈ alkyl sulfosuccinate, a C₆ to C₁₈ alkyl sulfosuccinate, a C₈ to C₁₈ alkyl sulfosuccinate, a C₁₀ to C₁₈ alkyl sulfosuccinate, a C₁₂ to C₁₈ alkyl sulfosuccinate, a C₂ to C₁₆ alkyl sulfosuccinate, a C₄ to C₁₆ alkyl sulfosuccinate, a C₆ to C₁₆ alkyl sulfosuccinate, a C₈ to C₁₆ alkyl sulfosuccinate, a C₁₀ to C₁₆ alkyl sulfosuccinate, a C₁₂ to C₁₆ alkyl sulfosuccinate, or a combination thereof.

The alkyl sulfate or alkyl sulfosuccinate can have a counterion of sodium, calcium, potassium, magnesium, ammonium, or a combination thereof.

The polymer composition described herein can further comprise a trialkyl amine or a trialkanol amine.

The trialkyl amine or trialkanol amine can comprise C₁ to C₁₀ alkyl groups, C₁ to C₈ alkyl groups, C₁ to C₆ alkyl groups, C₁ to C₄ alkyl groups, C₁ to C₂ alkyl groups, C₂ to C₁₀ alkyl groups, C₂ to C₈ alkyl groups, C₂ to C₆ alkyl groups, C₂ to C₄ alkyl groups, C₄ to C₁₀ alkyl groups, C₄ to C₈ alkyl groups, C₄ to C₆ alkyl groups, C₆ to C₁₀ alkyl groups, C₆ to C₈ alkyl groups, or C₈ to C₁₀ alkyl groups, or a combination thereof.

The trialkanol amine can comprise triethanol amine.

The oil-soluble polymer, the oil-miscible polymer, or the emulsifiable polymer of the polymer compositions described herein are derived from a monomer having a structure of Formula 1:

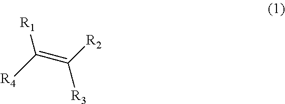

wherein R₁, R₃, and R₄ are independently hydrogen, alkyl, alkenyl, or aryl; R₂ is hydrogen, alkyl, alkenyl, aryl, —C(O)OR₅, or —C(O)NR₆R₇; and R₅, R₆, and R₇ are independently hydrogen, alkyl, alkenyl, or aryl.

The oil-soluble polymer, the oil-miscible polymer, or the emulsifiable polymer of the polymer compositions described herein are derived from a monomer having a structure of Formula 2:

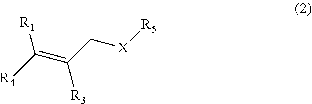

wherein R₁, R₃, and R₄ are independently hydrogen, alkyl, alkenyl, or aryl; X is —O— or —NR₆—; R₅ is hydrogen, alkyl, alkenyl, or aryl; and R₆ is hydrogen or alkyl.

For the monomers having a structure of Formula 1 or 2, R₁, R₃, and R₄ are independently hydrogen or C₁ to C₆ alkyl.

Monomers having a structure of Formula 1 or 2, can have R₁ and R₄ be hydrogen.

Monomers having a structure of Formula 1 or 2, can have R₃ be hydrogen or methyl.

Monomers having a structure of Formula 2, can have X be —O—.

Monomers having a structure of Formula 1 or 2, can have R₅ be C₁ to C₄₀ alkyl or C₁ to C₄₀ alkenyl.

Monomers having a structure of Formula 1 or 2, can have R₅ be 2-ethylhexyl.

The polymer compositions can have the oil-soluble polymer, the oil-miscible polymer, or the emulsifiable polymer be derived from a monomer comprising an acrylate, a methacrylate, an acrylate ester, a methacrylate ester, styrene, acrylic acid, methacrylic acid, an acrylamide, an alkyl styrene, a styrene sulfonate, a vinyl sulfonate, or a combination thereof.

Preferably, the oil-soluble polymer, the oil-miscible polymer, or the emulsifiable polymer can be derived from a monomer comprising methyl acrylate, methyl methacrylate, ethyl acrylate, ethyl methacrylate, propyl acrylate, propyl methacrylate, butyl acrylate, butyl methacrylate, iso-butyl acrylate, iso-butyl methacrylate, tert-butyl acrylate, tert-butyl methacrylate, pentyl acrylate, pentyl methacrylate, isopentyl acrylate, isopentyl methacrylate, hexyl acrylate, hexyl methacrylate, cyclohexyl acrylate, cyclohexyl methacrylate, heptyl acrylate, heptyl methacrylate, octyl acrylate, octyl methacrylate, iso-octyl acrylate, iso-octyl methacrylate, iso-decyl acrylate, iso-decyl methacrylate, lauryl acrylate, lauryl methacrylate, stearyl acrylate, stearyl methacrylate, behenyl acrylate, behenyl methacrylate, 2-ethylhexyl acrylate, 2-ethylhexyl methacrylate, 2-propylheptyl acrylate, 2-propylheptyl methacrylate, benzyl acrylate, benzyl methacrylate, 2-phenylethyl acrylate, 2-phenylethyl methacrylate, tridecyl acrylate, tridecyl methacrylate, iso-bornyl acrylate, iso-bornyl methacrylate, 3,5,5-trimethylhexyl acrylate, 3,5,5-trimethylhexyl methacrylate, 3,3,5-trimethylcyclohexyl acrylate, 3,3,5-trimethylcyclohexyl methacrylate, 2-hydroxyethyl acrylate, 2-hydroxyethyl methacrylate, 2-hydroxypropyl acrylate, 2-hydroxypropyl methacrylate, 2-hydroxybutyl acrylate, 2-hydroxybutyl methacrylate, 2-hydroxyethylcaprolactone acrylate, 2-hydroxyethylcaprolactone methacrylate, dihydrodicyclopentadienyl acrylate, dihydrodicyclopentadienyl methacrylate, ethyldiglycol acrylate, ethyldiglycol methacrylate, C₁₇ acrylate, C₁₇ methacrylate, vinylbenzylpolyoxyethylene alkyl ether, polyoxyethylene alkyl acrylate, polyoxyethylene alkyl methacrylate, or a combination or isomeric form thereof.

More preferably, the oil-soluble polymer, the oil-miscible polymer, or the emulsifiable polymer can be derived from a monomer comprising 2-ethylhexyl methacrylate, 2-ethylhexyl acrylate, or a combination thereof.

The polymer compositions can have the weight average molecular weight of the oil-soluble polymer, the oil-miscible polymer, or the emulsifiable polymer be greater than about 1,000,000 Daltons, about 2,000,000 Daltons, about 3,000,000 Daltons, about 4,000,000 Daltons, about 5,000,000 Daltons, about 50,000,000 Daltons, or about 100,000,000 Daltons as measured by gel permeation chromatography (GPC) against a polystyrene standard.

The polymer compositions can have the weight average molecular weight of the oil-soluble polymer, the oil-miscible polymer, or the emulsifiable polymer be from about 1,000,000 Daltons to about 200,000,000 Daltons, from about 2,000,000 Daltons to about 200,000,000 Daltons, from about 3,000,000 Daltons to about 200,000,000 Daltons, from about 4,000,000 Daltons to about 200,000,000 Daltons, from about 5,000,000 Daltons to about 200,000,000 Daltons, from about 1,000,000 Daltons to about 100,000,000 Daltons, from about 2,000,000 Daltons to about 100,000,000 Daltons, from about 3,000,000 Daltons to about 100,000,000 Daltons, from about 4,000,000 Daltons to about 100,000,000 Daltons, from about 5,000,000 Daltons to about 100,000,000 Daltons, from about 1,000,000 Daltons to about 50,000,000 Daltons, from about 2,000,000 Daltons to about 50,000,000 Daltons, from about 3,000,000 Daltons to about 50,000,000 Daltons, from about 4,000,000 Daltons to about 50,000,000 Daltons, or from about 5,000,000 Daltons to about 50,000,000 Daltons as measured by gel permeation chromatography (GPC) against a polystyrene standard.

Further, the polymer compositions can have the bulk viscosity of the polymer composition be less than about 500 centipoise, less than about 400 centipoise, less than about 300 centipoise, less than about 200 centipoise, less than about 100 centipoise, less than about 75 centipoise, or less than about 50 centipoise at a temperature of 22° C.

Additionally, the polymer composition described herein can have the oil-soluble polymer, the oil-miscible polymer, or the emulsifiable polymer have a concentration of from about 5 wt. % to about 75 wt. %, from about 10 wt. % to about 75 wt. %, from about 15 wt. % to about 75 wt. %, from about 20 wt. % to about 75 wt. %, from about 5 wt. % to about 65 wt. %, from about 10 wt. % to about 65 wt. %, from about 15 wt. % to about 65 wt. %, from about 20 wt. % to about 65 wt. %, from about 5 wt. % to about 55 wt. %, from about 10 wt. % to about 55 wt. %, from about 15 wt. % to about 55 wt. %, from about 20 wt. % to about 55 wt. %, from about 5 wt. % to about 50 wt. %, from about 10 wt. % to about 50 wt. %, from about 15 wt. % to about 50 wt. %, or from about 20 wt. % to about 50 wt. % in the polymer composition, based on the amount of the oil-soluble polymer, the oil-miscible polymer, or the emulsifiable polymer, additive, and water.

Also disclosed is a method of reducing drag resistance in a hydrocarbon fluid flowing in a fluid conduit. The method comprises injecting the polymer compositions disclosed herein into the conduit to contact the hydrocarbon fluid and thereby reduce the drag resistance of the hydrocarbon fluid in the conduit.

Also disclosed is a method of delivering the polymer compositions described herein to a hydrocarbon fluid recovered from a hydrocarbon-containing subterranean formation comprising transporting the polymer composition through a fluid conduit having a length of at least about 500 feet, wherein the viscosity of the polymer composition is less than 500 centipoise in the fluid conduit and the oil-soluble polymer, the oil-miscible polymer, or the emulsifiable polymer begins being released from the emulsion within 30 minutes of contacting the hydrocarbon fluid.

The viscosity of the polymer composition can be less than 100 centipoise in the fluid conduit and the oil-soluble polymer, the oil-miscible polymer, or the emulsifiable polymer can begin being released from the emulsion within 5 minutes of contacting the hydrocarbon fluid.

Also disclosed are methods of reducing the drag associated with transporting a hydrocarbon fluid through a subsea flowline comprising transporting the polymer compositions described herein through an umbilical line to the subsea flowline and contacting the polymer composition with the hydrocarbon fluid at an injection point.

The polymer compositions and methods described herein can have the oil-in-water emulsion invert to release at least 50% of the oil-soluble polymer, the oil-miscible polymer, or the emulsifiable polymer into a hydrocarbon fluid within 60 minutes after contacting the oil-in-water emulsion with the hydrocarbon fluid.

Additionally, the hydrocarbon fluid can further comprise an aqueous solution. For example, the hydrocarbon fluid can be part of a fluid in a hydrocarbon-containing subterranean formation that also contains an aqueous solution.

The hydrocarbon fluid that the oil-soluble polymer, the oil-miscible polymer, or the emulsifiable polymer is released into can comprise at least about 20 wt. %, 25 wt. %, 30 wt. %, 35 wt. %, 40 wt. % or more of hydrocarbon based on the total weight of the hydrocarbon fluid.

The polymer compositions or methods advantageously have the oil-in-water emulsion invert to release at least 95% of the oil-soluble polymer, the oil-miscible polymer, or the emulsifiable polymer into the hydrocarbon fluid within 9 minutes, within 8 minutes, within 7 minutes, within 6 minutes, within 5 minutes, within 4 minutes, within 3 minutes, or less after contacting the oil-in-water emulsion with the hydrocarbon fluid.

The hydrocarbon fluid contacted with the polymer compositions described herein can be recovered from a subterranean hydrocarbon-containing reservoir.

The hydrocarbon fluid recovered from the subterranean hydrocarbon-containing reservoir can be a produced fluid comprising at least about 20 wt. %, 25 wt. %, 30 wt. %, 35 wt. %, 40 wt. %, 45 wt. %, 50 wt. % or more hydrocarbon.

The polymer compositions described herein can have at least 60%, at least 70%, at least 80%, at least 90%, at least 95%, or more of the oil-soluble polymer, the oil-miscible polymer, or the emulsifiable polymer be released into the hydrocarbon fluid.

Also, the polymer composition can have the oil-soluble polymer, the oil-miscible polymer, or the emulsifiable polymer be released into the hydrocarbon fluid within 50 minutes, within 40 minutes, within 30 minutes, within 20 minutes, within 10 minutes, within 5 minutes, or less after contacting the oil-in-water emulsion with the hydrocarbon fluid.

The polymer compositions described herein can have the oil-in-water emulsion invert to release the oil-soluble polymer, the oil-miscible polymer, or the emulsifiable polymer into a hydrocarbon fluid resulting in at least 5%, 10%, 15%, 20%, 25%, 30%, 35%, or 40% drag reduction of the hydrocarbon fluid flowing in a conduit within 30 minutes, 25 minutes, 20 minutes, 15 minutes, 10 minutes, or 5 minutes after contacting the oil-in-water emulsion with the hydrocarbon fluid.

The polymer compositions described herein can have the oil-in-water emulsion invert to release the oil-soluble polymer, the oil-miscible polymer, or the emulsifiable polymer into a hydrocarbon fluid resulting in at least about 10%, 15%, 20%, 25%, 30%, 35%, 40%, or more drag reduction of the hydrocarbon fluid flowing in the fluid conduit.

The amount of the oil-soluble polymer, the oil-miscible polymer, or the emulsifiable polymer injected into the subsea flowline comprises from about 10 ppm to about 10,000 ppm, from about 10 ppm to about 5,000 ppm, from about 10 ppm to about 1,000 ppm, from about 10 ppm to about 750 ppm, from about 10 ppm to about 500 ppm, from about 25 ppm to about 10,000 ppm, from about 25 ppm to about 5,000 ppm, from about 25 ppm to about 1,000 ppm, from about 25 ppm to about 750 ppm, from about 25 ppm to about 500 ppm, from about 50 ppm to about 10,000 ppm, from about 50 ppm to about 5,000 ppm, from about 50 ppm to about 1,000 ppm, from about 50 ppm to about 750 ppm, or from about 50 ppm to about 500 ppm. Preferably, the amount of the oil-soluble polymer injected into the subsea flowline comprises from about 50 ppm to about 500 ppm based on the total amount of the produced fluid in the flowline.

The polymer compositions can be injected into an umbilical line that is part of an offshore production system. The offshore production system can include a plurality of subsea wellheads, a common production manifold, an offshore platform, a subsea flowline, and an umbilical line. Each wellhead can operate to produce a hydrocarbon-containing fluid from a subterranean hydrocarbon-containing formation. Each wellhead is also connected to the production manifold so that the produced hydrocarbon-containing fluid can flow and be combined with the produced hydrocarbons from other wellheads. The combined produced hydrocarbons can flow from the production manifold to the offshore platform through the subsea flowline. The umbilical line can be connected to a control device on the offshore platform and to either the wellheads, the production manifold, or the subsea flowline.

The length of the umbilical line is typically at least about 500 feet, more typically, at least about 1000 feet, or more.

The polymer compositions have physical properties that allow pumping through an umbilical line long distances at typical operating conditions of from 40° C. to 2° C. and a pressure from atmospheric pressure to 15,000 pounds per square inch (psi).

For the polymer to function as a drag reducer, the oil-soluble polymer, the oil-miscible polymer, or the emulsifiable polymer is dissolved or substantially (at least 50 wt. % of the polymer) solvated in the produced hydrocarbon fluid.

Further, in the methods, the polymer composition can comprise an effective amount of the components of the composition and an additional component selected from the group consisting of a corrosion inhibitor, an organic solvent, an asphaltene inhibitor, a paraffin inhibitor, a scale inhibitor, an emulsifier, a water clarifier, a dispersant, an emulsion breaker, a reverse emulsion breaker, a gas hydrate inhibitor, a biocide, a pH modifier, a surfactant, and a combination thereof.

The composition can comprise from about 10 to about 90 wt. % of the polymer composition components and from about 10 to about 80 wt. % of the additional component, preferably from about 50 to about 90 wt. % of polymer composition components and from about 10 to about 50 wt. % of the additional component, and more preferably from about 65 to about 85 wt. % of polymer composition components and from about 15 to about 35 wt. % of the additional component.

The additional component of the polymer composition can comprise water or an organic solvent. The composition can comprise from about 1 to 80 wt. %, from about 5 to 50 wt. %, or from about 10 to 35 wt. % of the water or the one or more organic solvents, based on total weight of the composition. The organic solvent can comprise an alcohol, a hydrocarbon, a ketone, an ether, an alkylene glycol, a glycol ether, an amide, a nitrile, a sulfoxide, an ester, or a combination thereof. Examples of suitable organic solvents include, but are not limited to, methanol, ethanol, propanol, isopropanol, butanol, 2-ethylhexanol, hexanol, octanol, decanol, 2-butoxyethanol, methylene glycol, ethylene glycol, 1,2-propylene glycol, 1,3-propylene glycol, diethyleneglycol monomethyl ether, diethylene glycol monoethyl ether, ethylene glycol monobutyl ether, ethylene glycol dibutyl ether, pentane, hexane, cyclohexane, methylcyclohexane, heptane, decane, dodecane, diesel, toluene, xylene, heavy aromatic naphtha, cyclohexanone, diisobutylketone, diethyl ether, propylene carbonate, N-methylpyrrolidinone, N,N-dimethylformamide, or a combination thereof.

The additional component of the polymer composition can comprise a corrosion inhibitor. The composition can comprise from about 0.1 to 20 wt. %, 0.1 to 10 wt. %, or 0.1 to 5 wt. % of the corrosion inhibitors, based on total weight of the composition. A composition can comprise from 0.1 to 10 percent by weight of the corrosion inhibitors, based on total weight of the composition. The composition can comprise 1.0 wt %, 1.5 wt %, 2.0 wt %, 2.5 wt %, 3.0 wt %, 3.5 wt %, 4.0 wt %, 4.5 wt %, 5.0 wt %, 5.5 wt %, 6.0 wt %, 6.5 wt %, 7.0 wt %, 7.5 wt %, 8.0 wt %, 8.5 wt %, 9.0 wt %, 9.5 wt %, 10.0 wt %, 10.5 wt %, 11.0 wt %, 11.5 wt %, 12.0 wt %, 12.5 wt %, 13.0 wt %, 13.5 wt %, 14.0 wt %, 14.5 wt %, or 15.0 wt % by weight of the corrosion inhibitors, based on total weight of the composition. Each system can have its own requirements, and the weight percent of one or more additional corrosion inhibitors in the composition can vary with the system in which it is used.

The corrosion inhibitor can comprise an imidazoline compound, a quaternary ammonium compound, a pyridinium compound, or a combination thereof.

The corrosion inhibitor component can comprise an imidazoline. The imidazoline can be, for example, imidazoline derived from a diamine, such as ethylene diamine (EDA), diethylene triamine (DETA), triethylene tetraamine (TETA) etc. and a long chain fatty acid such as tall oil fatty acid (TOFA). The imidazoline can be an imidazoline of Formula (I) or an imidazoline derivative. Representative imidazoline derivatives include an imidazolinium compound of Formula (II) or a bis-quaternized compound of Formula (III).

The corrosion inhibitor component can include an imidazoline of Formula (I):

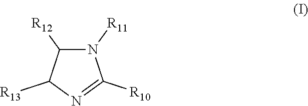

wherein R¹⁰ is a C₁-C₂₀ alkyl or a C₁-C₂₀ alkoxyalkyl group; R¹¹ is hydrogen, C₁-C₆ alkyl, C₁-C₆ hydroxyalkyl, or C₁-C₆ arylalkyl; and R¹² and R¹³ are independently hydrogen or a C₁-C₆ alkyl group. Preferably, the imidazoline includes an R¹⁰ which is the alkyl mixture typical in tall oil fatty acid (TOFA), and R¹¹, R¹² and R¹³ are each hydrogen.

The corrosion inhibitor component can include an imidazolinium compound of Formula (II):

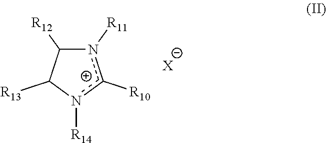

wherein R¹⁰ is a C₁-C₂₀ alkyl or a C₁-C₂₀ alkoxyalkyl group; R¹¹ and R¹⁴ are independently hydrogen, C₁-C₆ alkyl, C₁-C₆ hydroxyalkyl, or C₁-C₆ arylalkyl; R¹² and R¹³ are independently hydrogen or a C₁-C₆ alkyl group; and X⁻ is a halide (such as chloride, bromide, or iodide), carbonate, sulfonate, phosphate, or the anion of an organic carboxylic acid (such as acetate). Preferably, the imidazolinium compound includes 1-benzyl-1-(2-hydroxyethyl)-2-tall-oil-2-imidazolinium chloride.

The corrosion inhibitor can comprise a bis-quaternized compound having the formula (III):

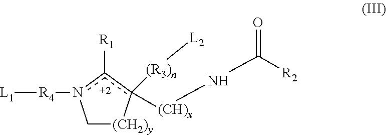

wherein R₁ and R₂ are each independently unsubstituted branched, chain or ring alkyl or alkenyl having from 1 to about 29 carbon atoms; partially or fully oxygenized, sulfurized, and/or phosphorylized branched, chain, or ring alkyl or alkenyl having from 1 to about 29 carbon atoms; or a combination thereof; R₃ and R₄ are each independently unsubstituted branched, chain or ring alkylene or alkenylene having from 1 to about 29 carbon atoms; partially or fully oxygenized, sulfurized, and/or phosphorylized branched, chain, or ring alkylene or alkenylene having from 1 to about 29 carbon atoms; or a combination thereof; L₁ and L₂ are each independently absent, H, —COOH, —SO₃H, —PO₃H₂, —COOR₅, —CONH₂, —CONHR₅, or —CON(R₅)₂; R₅ is each independently a branched or unbranched alkyl, aryl, alkylaryl, alkylheteroaryl, cycloalkyl, or heteroaryl group having from 1 to about 10 carbon atoms; n is 0 or 1, and when n is 0, L₂ is absent or H; x is from 1 to about 10; and y is from 1 to about 5. Preferably, R₁ and R₂ are each independently C₆-C₂₂ alkyl, C₈-C₂₀ alkyl, C₁₂-C₁₈ alkyl, C₁₆-C₁₈ alkyl, or a combination thereof; R₃ and R₄ are C₁-C₁₀ alkylene, C₂-C₈ alkylene, C₂-C₆ alkylene, or C₂-C₃ alkylene; n is 0 or 1; x is 2; y is 1; R₃ and R₄ are —C₂H₂—; L₁ is —COOH, —SO₃H, or —PO₃H₂; and L₂ is absent, H, —COOH, —SO₃H, or —PO₃H₂. For example, R₁ and R₂ can be derived from a mixture of tall oil fatty acids and are predominantly a mixture of C₁₇H₃₃ and C₁₇H₃₁ or can be C₁₆-C₁₈ alkyl; R₃ and R₄ can be C₂-C₃ alkylene such as —C₂H₂—; n is 1 and L₂ is —COOH or n is 0 and L₂ is absent or H; x is 2; y is 1; R₃ and R₄ are —C₂H₂—; and L₁ is —COOH.

It should be appreciated that the number of carbon atoms specified for each group of formula (III) refers to the main chain of carbon atoms and does not include carbon atoms that may be contributed by substituents.

The corrosion inhibitor can comprise a bis-quaternized imidazoline compound having the formula (III) wherein R₁ and R₂ are each independently C₆-C₂₂ alkyl, C₈-C₂₀ alkyl, C₁₂-C₁₈ alkyl, or C₁₆-C₁₈ alkyl or a combination thereof; R₄ is C₁-C₁₀ alkylene, C₂-C₈ alkylene, C₂-C₆ alkylene, or C₂-C₃ alkylene; x is 2; y is 1; n is 0; L₁ is —COOH, —SO₃H, or —PO₃H₂; and L₂ is absent or H. Preferably, a bis-quaternized compound has the formula (III) wherein R₁ and R₂ are each independently C₁₆-C₁₈ alkyl; R₄ is —C₂H₂—; x is 2; y is 1; n is 0; L₁ is-OOH, —SO₃H, or —PO₃H₂ and L₂ is absent or H.

The corrosion inhibitor can be a quaternary ammonium compound of Formula (IV):

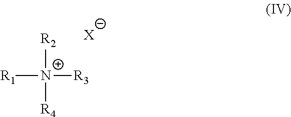

wherein R₁, R₂, and R₃ are independently C₁ to C₂₀ alkyl, R₄ is methyl or benzyl, and X⁻ is a halide or methosulfate.

Suitable alkyl, hydroxyalkyl, alkylaryl, arylalkyl or aryl amine quaternary salts include those alkylaryl, arylalkyl and aryl amine quaternary salts of the formula [N⁺R^{5a}R^{6a}R^{7a}R^{8a}][X⁻] wherein R⁵, R^{6a}, R^{7a}, and R^{8a} contain one to 18 carbon atoms, and X is Cl, Br or I. For the quaternary salts, R^{5a}, R^{6a}, R^{7a}, and R^{8a} can each be independently selected from the group consisting of alkyl (e.g., C₁-C₁₈ alkyl), hydroxyalkyl (e.g., C₁-C₁₈ hydroxyalkyl), and arylalkyl (e.g., benzyl). The mono or polycyclic aromatic amine salt with an alkyl or alkylaryl halide include salts of the formula [N⁺R^{5a}R^{6a}R^{7a}R^{8a}][X⁻] wherein R⁵, R⁶, R^{7a}, and R^{8a} contain one to 18 carbon atoms and at least one aryl group, and X is Cl, Br or I.

Suitable quaternary ammonium salts include, but are not limited to, a tetramethyl ammonium salt, a tetraethyl ammonium salt, a tetrapropyl ammonium salt, a tetrabutyl ammonium salt, a tetrahexyl ammonium salt, a tetraoctyl ammonium salt, a benzyltrimethyl ammonium salt, a benzyltriethyl ammonium salt, a phenyltrimethyl ammonium salt, a phenyltriethyl ammonium salt, a cetyl benzyldimethyl ammonium salt, a hexadecyl trimethyl ammonium salt, a dimethyl alkyl benzyl quaternary ammonium salt, a monomethyl dialkyl benzyl quaternary ammonium salt, or a trialkyl benzyl quaternary ammonium salt, wherein the alkyl group has about 6 to about 24 carbon atoms, about 10 and about 18 carbon atoms, or about 12 to about 16 carbon atoms. The quaternary ammonium salt can be a benzyl trialkyl quaternary ammonium salt, a benzyl triethanolamine quaternary ammonium salt, or a benzyl dimethylaminoethanolamine quaternary ammonium salt.

The corrosion inhibitor component can comprise a pyridinium salt such as those represented by Formula (V):

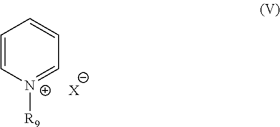

wherein R⁹ is an alkyl group, an aryl group, or an arylalkyl group, wherein said alkyl groups have from 1 to about 18 carbon atoms and X⁻ is a halide such as chloride, bromide, or iodide. Among these compounds are alkyl pyridinium salts and alkyl pyridinium benzyl quats. Exemplary compounds include methyl pyridinium chloride, ethyl pyridinium chloride, propyl pyridinium chloride, butyl pyridinium chloride, octyl pyridinium chloride, decyl pyridinium chloride, lauryl pyridinium chloride, cetyl pyridinium chloride, benzyl pyridinium chloride and an alkyl benzyl pyridinium chloride, preferably wherein the alkyl is a C₁-C₆ hydrocarbyl group. Preferably, the pyridinium compound includes benzyl pyridinium chloride.

The corrosion inhibitor components can also include phosphate esters, monomeric or oligomeric fatty acids, or alkoxylated amines.

The corrosion inhibitor component can comprise a phosphate ester. Suitable mono-, di- and tri-alkyl as well as alkylaryl phosphate esters and phosphate esters of mono, di, and triethanolamine typically contain between from 1 to about 18 carbon atoms. Preferred mono-, di- and trialkyl phosphate esters, alkylaryl or arylalkyl phosphate esters are those prepared by reacting a C₃-C₁₈ aliphatic alcohol with phosphorous pentoxide. The phosphate intermediate interchanges its ester groups with triethylphosphate producing a more broad distribution of alkyl phosphate esters.

Alternatively, the phosphate ester can be made by admixing with an alkyl diester, a mixture of low molecular weight alkyl alcohols or diols. The low molecular weight alkyl alcohols or diols preferably include C₆ to C₁₀ alcohols or diols. Further, phosphate esters of polyols and their salts containing one or more 2-hydroxyethyl groups, and hydroxylamine phosphate esters obtained by reacting polyphosphoric acid or phosphorus pentoxide with hydroxylamines such as diethanolamine or triethanolamine are preferred.

The corrosion inhibitor component can include a monomeric or oligomeric fatty acid. Preferred monomeric or oligomeric fatty acids are C₁₄-C₂₂ saturated and unsaturated fatty acids as well as dimer, trimer and oligomer products obtained by polymerizing one or more of such fatty acids.

The corrosion inhibitor component can comprise an alkoxylated amine. The alkoxylated amine can be an ethoxylated alkyl amine. The alkoxylated amine can be ethoxylated tallow amine.

The additional component of the composition can comprise an organic sulfur compound, such as a mercaptoalkyl alcohol, mercaptoacetic acid, thioglycolic acid, 3,3′-dithiodipropionic acid, sodium thiosulfate, thiourea, L-cysteine, tert-butyl mercaptan, sodium thiosulfate, ammonium thiosulfate, sodium thiocyanate, ammonium thiocyanate, sodium metabisulfite, or a combination thereof. Preferably, the mercaptoalkyl alcohol comprises 2-mercaptoethanol. The organic sulfur compound can constitute 0.5 to 15 wt. % of the composition, based on total weight of the composition, preferably about 1 to about 10 wt. % and more preferably about 1 to about 5 wt. %. The organic sulfur compound can constitute 1, 2, 3, 4, 5, 6, 7, 8, 9, 10, 11, 12, 13, 14 or 15 wt. % of the composition.

The composition can be substantially free of or free of any organic sulfur compound. A composition is substantially free of any organic sulfur compound if it contains an amount of organic sulfur compound below the amount that will produce hydrogen sulfide gas upon storage at a temperature of 25° C. and ambient pressure.

The composition can comprise a demulsifier. Preferably, the demulsifier comprises an oxyalkylate polymer, such as a polyalkylene glycol. The demulsifier can constitute from about 0.1 to 10 wt. %, from about 0.5 to 5 wt. %, or from about 0.5 to 4 wt. % of the composition, based on total weight of the composition. The demulsifier can constitute 0.5, 1, 1.5, 2, 2.5, 3, 3.5, 4, 4.5 or 5 wt. % of the composition.

The composition can include an asphaltene inhibitor. The composition can comprise from about 0.1 to 10 wt. %, from about 0.1 to 5 wt. %, or from about 0.5 to 4 wt. % of an asphaltene inhibitor, based on total weight of the composition. Suitable asphaltene inhibitors include, but are not limited to, aliphatic sulfonic acids; alkyl aryl sulfonic acids; aryl sulfonates; lignosulfonates; alkylphenol/aldehyde resins and similar sulfonated resins; polyolefin esters; polyolefin imides; polyolefin esters with alkyl, alkylenephenyl or alkylenepyridyl functional groups; polyolefin amides; polyolefin amides with alkyl, alkylenephenyl or alkylenepyridyl functional groups; polyolefin imides with alkyl, alkylenephenyl or alkylenepyridyl functional groups; alkenyl/vinyl pyrrolidone copolymers; graft polymers of polyolefins with maleic anhydride or vinyl imidazole; hyperbranched polyester amides; polyalkoxylated asphaltenes, amphoteric fatty acids, salts of alkyl succinates, sorbitan monooleate, and polyisobutylene succinic anhydride.

The composition can include a paraffin inhibitor. The composition can comprise from about 0.1 to 10 wt. %, from about 0.1 to 5 wt. %, or from about 0.5 to 4 wt. % of a paraffin inhibitor, based on total weight of the composition. Suitable paraffin inhibitors include, but are not limited to, paraffin crystal modifiers, and dispersant/crystal modifier combinations. Suitable paraffin crystal modifiers include, but are not limited to, alkyl acrylate copolymers, alkyl acrylate vinylpyridine copolymers, ethylene vinyl acetate copolymers, maleic anhydride ester copolymers, branched polyethylenes, naphthalene, anthracene, microcrystalline wax and/or asphaltenes. Suitable paraffin dispersants include, but are not limited to, dodecyl benzene sulfonate, oxyalkylated alkylphenols, and oxyalkylated alkylphenolic resins.

The composition can include a scale inhibitor. The composition can comprise from about 0.1 to 20 wt. %, from about 0.5 to 10 wt. %, or from about 1 to 10 wt. % of a scale inhibitor, based on total weight of the composition. Suitable scale inhibitors include, but are not limited to, phosphates, phosphate esters, phosphoric acids, phosphonates, phosphonic acids, polyacrylamides, salts of acrylamidomethyl propane sulfonate/acrylic acid copolymer (AMPS/AA), phosphinated maleic copolymer (PHOS/MA), and salts of a polymaleic acid/acrylic acid/acrylamidomethyl propane sulfonate terpolymer (PMA/AA/AMPS).

The composition can include an emulsifier. The composition can comprise from about 0.1 to 10 wt. %, from about 0.5 to 5 wt. %, or from about 0.5 to 4 wt. % of an emulsifier, based on total weight of the composition. Suitable emulsifiers include, but are not limited to, salts of carboxylic acids, products of acylation reactions between carboxylic acids or carboxylic anhydrides and amines, and alkyl, acyl and amide derivatives of saccharides (alkyl-saccharide emulsifiers).

The composition can include a water clarifier. The composition can comprise from about 0.1 to 10 wt. %, from about 0.5 to 5 wt. %, or from about 0.5 to 4 wt. % of a water clarifier, based on total weight of the composition. Suitable water clarifiers include, but are not limited to, inorganic metal salts such as alum, aluminum chloride, and aluminum chlorohydrate, or organic polymers such as acrylic acid based polymers, acrylamide based polymers, polymerized amines, alkanolamines, thiocarbamates, and cationic polymers such as diallyldimethylammonium chloride (DADMAC).

The composition can include a dispersant. The composition can comprise from about 0.1 to 10 wt. %, from about 0.5 to 5 wt. %, or from about 0.5 to 4 wt. % of a dispersant, based on total weight of the composition. Suitable dispersants include, but are not limited to, aliphatic phosphonic acids with 2-50 carbons, such as hydroxyethyl diphosphonic acid, and aminoalkyl phosphonic acids, e.g. polyaminomethylene phosphonates with 2-10 N atoms e.g. each bearing at least one methylene phosphonic acid group; examples of the latter are ethylenediamine tetra(methylene phosphonate), diethylenetriamine penta(methylene phosphonate), and the triamine- and tetramine-polymethylene phosphonates with 2-4 methylene groups between each N atom, at least 2 of the numbers of methylene groups in each phosphonate being different. Other suitable dispersion agents include lignin, or derivatives of lignin such as lignosulfonate and naphthalene sulfonic acid and derivatives.

The composition can include an emulsion breaker. The composition can comprise from about 0.1 to 10 wt. %, from about 0.5 to 5 wt. %, or from about 0.5 to 4 wt. % of an emulsion breaker, based on total weight of the composition. Suitable emulsion breakers include, but are not limited to, dodecylbenzylsulfonic acid (DDBSA), the sodium salt of xylenesulfonic acid (NAXSA), epoxylated and propoxylated compounds, anionic, cationic and nonionic surfactants, and resins, such as phenolic and epoxide resins.

The composition can include a hydrogen sulfide scavenger. The composition can comprise from about 1 to 50 wt. %, from about 1 to 40 wt. %, or from about 1 to 30 wt. % of a hydrogen sulfide scavenger, based on total weight of the composition. Suitable additional hydrogen sulfide scavengers include, but are not limited to, oxidants (e.g., inorganic peroxides such as sodium peroxide or chlorine dioxide); aldehydes (e.g., of 1-10 carbons such as formaldehyde, glyoxal, glutaraldehyde, acrolein, or methacrolein; triazines (e.g., monoethanolamine triazine, monomethylamine triazine, and triazines from multiple amines or mixtures thereof); condensation products of secondary or tertiary amines and aldehydes, and condensation products of alkyl alcohols and aldehydes.

The composition can include a gas hydrate inhibitor. The composition can comprise from about 0.1 to 25 wt. %, from about 0.1 to 20 wt. %, or from about 0.3 to 20 wt. % of a gas hydrate inhibitor, based on total weight of the composition. Suitable gas hydrate inhibitors include, but are not limited to, thermodynamic hydrate inhibitors (THI), kinetic hydrate inhibitors (KHI), and anti-agglomerates (AA). Suitable thermodynamic hydrate inhibitors include, but are not limited to, sodium chloride, potassium chloride, calcium chloride, magnesium chloride, sodium bromide, formate brines (e.g. potassium formate), polyols (such as glucose, sucrose, fructose, maltose, lactose, gluconate, monoethylene glycol, diethylene glycol, triethylene glycol, mono-propylene glycol, dipropylene glycol, tripropylene glycols, tetrapropylene glycol, monobutylene glycol, dibutylene glycol, tributylene glycol, glycerol, diglycerol, triglycerol, and sugar alcohols (e.g. sorbitol, mannitol)), methanol, propanol, ethanol, glycol ethers (such as diethyleneglycol monomethylether, ethyleneglycol monobutylether), and alkyl or cyclic esters of alcohols (such as ethyl lactate, butyl lactate, methylethyl benzoate).

The composition can include a kinetic hydrate inhibitor. The composition can comprise from about 5 to 30 wt. %, from about 5 to 25 wt. %, or from about 10 to 25 wt. % of a kinetic hydrate inhibitor, based on total weight of the composition. Suitable kinetic hydrate inhibitors and anti-agglomerates include, but are not limited to, polymers and copolymers, polysaccharides (such as hydroxyethylcellulose (HEC), carboxymethylcellulose (CMC), starch, starch derivatives, and xanthan), lactams (such as polyvinylcaprolactam, polyvinyl lactam), pyrrolidones (such as polyvinyl pyrrolidone of various molecular weights), surfactants (such as fatty acid salts, ethoxylated alcohols, propoxylated alcohols, sorbitan esters, ethoxylated sorbitan esters, polyglycerol derivatives of fatty acids, alkyl glucosides, alkyl polyglucosides, alkyl sulfates, alkyl sulfonates, alkyl ester sulfonates, alkyl aromatic sulfonates, alkyl betaine, alkyl amido betaines), hydrocarbon based dispersants (such as lignosulfonates, iminodisuccinates, polyaspartates), amino acids, and proteins.

The composition can include a biocide. The composition can comprise from about 0.1 to 10 wt. %, from about 0.5 to 5 wt. %, or from about 0.5 to 4 wt. % of a biocide, based on total weight of the composition. Suitable biocides include, but are not limited to, oxidizing and non-oxidizing biocides. Suitable non-oxidizing biocides include, for example, aldehydes (e.g., formaldehyde, glutaraldehyde, and acrolein), amine-type compounds (e.g., quaternary amine compounds and cocodiamine), halogenated compounds (e.g., 2-bromo-2-nitropropane-3-diol (Bronopol) and 2-2-dibromo-3-nitrilopropionamide (DBNPA)), sulfur compounds (e.g., isothiazolone, carbamates, and metronidazole), and quaternary phosphonium salts (e.g., tetrakis(hydroxymethyl)-phosphonium sulfate (THPS)). Suitable oxidizing biocides include, for example, sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, and peroxides.

The composition can include a pH modifier. The composition can comprise from about 0.1 to 20 wt. %, from about 0.5 to 10 wt. %, or from about 0.5 to 5 wt. % of a pH modifier, based on total weight of the composition. Suitable pH modifiers include, but are not limited to, alkali hydroxides, alkali carbonates, alkali bicarbonates, alkaline earth metal hydroxides, alkaline earth metal carbonates, alkaline earth metal bicarbonates and mixtures or combinations thereof. Exemplary pH modifiers include sodium hydroxide, potassium hydroxide, calcium hydroxide, calcium oxide, sodium carbonate, potassium carbonate, sodium bicarbonate, potassium bicarbonate, magnesium oxide, and magnesium hydroxide.

The composition can include a surfactant. The composition can comprise from about 0.1 to 10 wt. %, from about 0.5 to 5 wt. %, or from about 0.5 to 4 wt. % of a surfactant, based on total weight of the composition. Suitable surfactants include, but are not limited to, anionic surfactants and nonionic surfactants. Anionic surfactants include alkyl aryl sulfonates, olefin sulfonates, paraffin sulfonates, alcohol sulfates, alcohol ether sulfates, alkyl carboxylates and alkyl ether carboxylates, and alkyl and ethoxylated alkyl phosphate esters, and mono and dialkyl sulfosuccinates and sulfosuccinamates. Nonionic surfactants include alcohol alkoxylates, alkylphenol alkoxylates, block copolymers of ethylene, propylene and butylene oxides, alkyl dimethyl amine oxides, alkyl-bis(2-hydroxyethyl) amine oxides, alkyl amidopropyl dimethyl amine oxides, alkylamidopropyl-bis(2-hydroxyethyl) amine oxides, alkyl polyglucosides, polyalkoxylated glycerides, sorbitan esters and polyalkoxylated sorbitan esters, and alkoyl polyethylene glycol esters and diesters. Also included are betaines and sultanes, amphoteric surfactants such as alkyl amphoacetates and amphodiacetates, alkyl amphopropionates and amphodipropionates, and alkyliminodipropionate.

Polymer compositions made according to the invention can further include additional functional agents or additives that provide a beneficial property. Polymer compositions of the invention may include any combination of the following additional agents or additives. Such additional agents or additives include sequestrants, solubilizers, lubricants, buffers, cleaning agents, rinse aids, preservatives, binders, thickeners or other viscosity modifiers, processing aids, carriers, water-conditioning agents, foam inhibitors or foam generators, threshold agents or systems, aesthetic enhancing agents (i.e., dyes, odorants, perfumes), or other additives suitable for formulation with a corrosion inhibitor composition, and mixtures thereof. Additional agents or additives will vary according to the particular polymer composition being manufactured and its intended use as one skilled in the art will appreciate.

Alternatively, the compositions may be devoid of any of the additional agents or additives.

Additionally, the polymer composition can be formulated into a treatment fluid comprising the following components. These formulations include the ranges of the components listed and can optionally include additional agents.

| Component | 1 | 2 | 3 | 4 | 5 | 6 | 7 | 8 | 9 | 10 | 11 | 12 |
|---|---|---|---|---|---|---|---|---|---|---|---|---|
| Polymer composition | 10-90 | 10-90 | 10-90 | 10-90 | 10-90 | 10-90 | 25-85 | 25-85 | 25-85 | 25-85 | 25-85 | 10-90 |
| (wt. %) | | | | | | | | | | | | |
| Organic solvent | 10-35 | | | | | | 10-35 | | | | | 10-35 |
| (wt. %) | | | | | | | | | | | | |
| Corrosion inhibitor | 0.1-20 | 0.1-20 | | | | | 0.1-20 | 0.1-20 | | | | 0.1-20 |
| (wt. %) | | | | | | | | | | | | |
| Asphaltene inhibitor | 0.1-5 | 0.1-5 | 0.1-5 | 0.1-5 | | | 0.1-5 | 0.1-5 | 0.1-5 | | | 0.1-5 |
| (wt. %) | | | | | | | | | | | | |
| Paraffin inhibitor | | | | | | | | | | | | |
| (wt. %) | | | | | | | | | | | | |
| Scale inhibitor (wt. %) | 1-10 | 1-10 | 1-10 | 1-10 | 1-10 | | 1-10 | 1-10 | 1-10 | 1-10 | | 1-10 |
| Emulsifier (wt. %) | | | | | | | | | | | | |
| Water clarifier (wt. %) | | | | | | | | | | | | |
| Dispersant (wt. %) | | | | | | | | | | | | |
| Emulsion breaker | | | | | | | | | | | | |
| (wt. %) | | | | | | | | | | | | |
| Gas hydrate inhibitor | | | | | | | | | | | | 0.1-25 |
| (wt. %) | | | | | | | | | | | | |
| Biocide (wt. %) | 0.5-5 | 0.5-5 | 0.5-5 | 0.5-5 | 0.5-5 | 0.5-5 | 0.5-5 | 0.5-5 | 0.5-5 | 0.5-5 | 0.5-5 | |
| Component | 13 | 14 | 15 | 16 | 17 | 18 | 19 | 20 | 21 | 22 | 23 | 24 |
| Polymer composition | 10-90 | 10-90 | 10-90 | 10-90 | 10-90 | 10-90 | 25-85 | 25-85 | 25-85 | 25-85 | 25-85 | 25-85 |
| (wt. %) | | | | | | | | | | | | |
| Organic solvent | | | | | | | | | | | | |
| (wt. %) | | | | | | | | | | | | |
| Corrosion inhibitor | 0.1-20 | 0.1-20 | 0.1-20 | 0.1-20 | 0.1-20 | 0.1-20 | 0.1-20 | 0.1-20 | 0.1-20 | 0.1-20 | 0.1-20 | 0.1-20 |
| (wt. %) | | | | | | | | | | | | |
| Asphaltene inhibitor | 0.1-5 | | | | | | 0.1-5 | | | | | |
| (wt. %) | | | | | | | | | | | | |
| Paraffin inhibitor | | | | | | | | | | | | |
| (wt. %) | | | | | | | | | | | | |
| Scale inhibitor | 1-10 | 1-10 | | | 1-10 | | 1-10 | 1-10 | | | | 1-10 |
| (wt. %) | | | | | | | | | | | | |
| Emulsifier (wt. %) | | | | | | | | | | | | |
| Water clarifier (wt. %) | | | | | | | | | | | | |
| Dispersant (wt. %) | | | | | | | | | | | | |
| Emulsion breaker | | | | | | | | | | | | |
| (wt. %) | | | | | | | | | | | | |
| Gas hydrate inhibitor | 0.1-25 | 0.1-25 | 0.1-25 | | | | 0.1-25 | 0.1-25 | 0.1-25 | | 0.1-25 | |
| (wt. %) | | | | | | | | | | | | |
| Biocide (wt. %) | | | | | | 0.5-5 | 0.5-5 | 0.5-5 | 0.5-5 | 0.5-5 | | |

### Definitions

The percentage of polymer released to a hydrocarbon of a polymer emulsion can be measured by normalizing the maximum drag reduction obtained from a flow loop test of the sample injected in the neat (as-is) form to the maximum drag reduction obtained from a flow loop test at the same testing conditions of the same sample injected in the pre-dissolved (made-down) form. For example, if a polymer emulsion sample injected into a hydrocarbon in its pre-dissolved (make-down) solution gives a maximum drag reduction of 60% and the same sample injected into the same hydrocarbon in its neat (as-is) form gives a maximum drag reduction of 45%, the percentage of polymer released to the hydrocarbon is 75%. The polymer compositions containing the oil-in-water emulsions described herein are substantially stable. The compositions are stable in that they can be stored for a period of time and used as effective drag reducers without further modification. For example, less than 10 wt. %, less than 9 wt. %, less than 8 wt. %, less than 7 wt. %, less than 6 wt. %, less than 5 wt. %, or less of the oil-in-water emulsion particles are dissolved in the continuous phase over a 6 month storage period.

Unless otherwise defined, the polyglycerol derivative comprises a polyglycerol alkyl ether, a polyglycerol alkyl ester, or a combination thereof.

A storage stable emulsion remains in a continuous phase with no phase separation for at least 14 days at a storage temperature from about −6.7° C. to about 60° C.

The term “alkyl,” as used herein, refers to a linear or branched hydrocarbon radical, preferably having 1 to 32 carbon atoms (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons). Alkyl groups include, but are not limited to, methyl, ethyl, n-propyl, isopropyl, n-butyl, iso-butyl, secondary-butyl, and tertiary-butyl. Alkyl groups may be unsubstituted or substituted by one or more suitable substituents, as defined above.

The term “alkenyl,” as used herein, refers to a straight or branched hydrocarbon radical, preferably having 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons, and having one or more carbon-carbon double bonds. Alkenyl groups include, but are not limited to, ethenyl, 1-propenyl, 2-propenyl (allyl), iso-propenyl, 2-methyl-1-propenyl, 1-butenyl, and 2-butenyl. Alkenyl groups may be unsubstituted or substituted by one or more suitable substituents, as defined above.

The term “aryl,” as used herein, means monocyclic, bicyclic, or tricyclic aromatic radicals such as phenyl, naphthyl, tetrahydronaphthyl, indanyl and the like; optionally substituted by one or more suitable substituents, preferably 1 to 5 suitable substituents, as defined above.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

Having described the invention in detail, it will be apparent that modifications and variations are possible without departing from the scope of the invention defined in the appended claims.

### EXAMPLES

The following non-limiting examples are provided to further illustrate the present invention.

### Example 1: Polyglycerol Additives

Polymer molecular weights (MW) by GPC and polydispersity (PD) are listed in Table 1 for polyglycerol in additives comprising polyglycerol. Additive PG-C, an additive comprising polyglycerol, is commercially available from Nalco as product DVP4V029.

TABLE 1
Polyglycerol additives

| | | Molecular | | |
|---|---|---|---|---|
| Polyglycerol | | Weight | Poly- | Actives |
| Additives | Description | (Dalton) | dispersity | (wt. %) |
| PG-A | Polyglycerol-3, | 220 | 1.1 | 50.0% |
| | a commercial product | | | |
| | from Solvay | | | |
| PG-B | Polyglycerol produced | 260 | 1.2 | 50.0% |
| | by Nalco | | | |
| PG-C | DVP4V029, | 400 | 1.4 | 50.0% |
| | a commercial | | | |
| | polyglycerol | | | |
| | produced | | | |
| | by Nalco | | | |
| PG-D | Polyglycerol produced | 3,900 | 2.3 | 50.0% |
| | by Nalco | | | |
| PG-E | Lipophilic polyglycerol | 16,000 | 11 | 40.0% |
| | (C₁₀—C₁₆ alkyl | | | |
| | polyglycerol ether) | | | |
| | produced by | | | |
| | Nalco | | | |

### Example 2: Surfactant Additives

TABLE 2
Surfactant additives

| Surfactant | | Actives |
|---|---|---|
| Additives | Description | (wt. %) |
| S-F | Sodium lactate | 63.11% |
| S-G | Sodium lauryl ether sulfate, ethoxylated | 28.5% |
| | (Stepan STEOL ® CS330) | |
| S-H | Bis(2-ethylhexyl) sulfosuccinate sodium salt | 70% |
| | (Croda Monawet MO-70R) | |
| S-I | Sulfonic acids, C15-20-alkane hydroxy and | 30% |
| | C15-20-alkene, sodium salts (Shell | |
| | ENORDET ™ 0332) | |
| S-J | Sodium octyl sulfate (Stepan POLYSTEP ® B- | 20% |
| | 29) | |
| S-K | Sodium dodecyl sulfate (Norman, Fox & Co. | 10% |
| | NORFOX ® SLS) | |

Chemical description and actives percentages of surfactant additives are listed in Table 2.

### Example 3: Compositions of Oil-in-Water Emulsions

An oil-in-water emulsion comprising poly(2-ethylhexyl methacrylate) can be used for drag reduction in subsea crude oil flowlines. A polymer composition without additive, named Comp-1, is listed in Table 3.

Comp-1 was prepared by charging water, a chelator (e.g., disodium ethylenediamine tetraacetic acid) at a concentration of approximately 0.025 wt. %, and an antifoaming agent (e.g., silicone antifoam) at a concentration of approximately 0.01 wt. % into a reactor and stirring the mixture for about 15 minutes at 330 rpm and a temperature of about 20° C. to about 25° C. After stirring, a surfactant (e.g., ethoxylated octylphenol) was charged to the reactor at a concentration of approximately 4 wt. % and the reactor was purged with nitrogen from the bottom of the reactor for at least 15 minutes and the nitrogen purge was continued throughout the reaction time. After the reactor was purged with nitrogen for at least 15 minutes, the monomer of Formula 1 (e.g., 2-ethylhexyl methacrylate) was charged to the reactor and the mixture was stirred for 30 minutes and the temperature was adjusted to about 20° C. to about 25° C. if needed.

The polymerization reaction was initiated by addition of redox agents such as sodium metabisulfite and tert-butyl hydroperoxide. These reagents were increased slowly over time to provide a concentration in the reaction mixture of approximately 0.025 wt. % sodium metabisulfite and approximately 0.002 wt. % tert-butyl hydroperoxide. The nitrogen purge was also changed to sweep the headspace of the reactor. An exothermic reaction was expected and the addition rates of the redox solutions were added if an exotherm was not observed. The reaction time was approximately 2.5 to 3 hours and once the reaction was approximately 95% complete as determined by density measurement, optionally, a chain transfer agent (e.g., dodecyl mercaptan at about 1000 ppm) was added, and then the addition rate of the redox solutions was increased to complete the addition. After all of the redox solutions were added to the reactor, the mixture was stirred for 30 minutes.

TABLE 3
Composition of oil-in-water emulsion comprising
poly(2-ethylhexyl methacrylate) - Comp-1

| Description | CAS# | Composition |
|---|---|---|
| Water | 7732-18-5 | 57.861% |
| ethoxylated octyphenol (Triton X-114) | 9036-19-5 | 3.920% |
| polyethylene glycol | 225322-68-3 | 0.080% |
| poly(dimethylsiloxane) | 63148-62-9 | 0.010% |
| disodium EDTA | 139-33-3 | 0.025% |
| 2-ethylhexyl methacrylate | 25719-51-1 | 38.1045% |
| homopolymer | | |
| Total | | 100.000% |

TABLE 4
Examples of compositions comprising
Comp-1 and various additives

| | | % of | % of |
|---|---|---|---|
| | | Additive(s) in | Comp-1 in |
| Composition | | composition | composition |
| ID | Additives | (wt. %) | (wt. %) |
| Comp-2 | Commercial glycerol | 8.00% | 92.00% |
| Comp-3 | PG-A | 16.00% | 84.00% |
| Comp-4 | PG-B | 16.00% | 84.00% |
| Comp-5 | PG-C | 8.00% | 92.00% |
| Comp-6 | PG-C | 16.00% | 84.00% |
| Comp-7 | PG-D | 16.00% | 84.00% |
| Comp-8 | PG-E | 10.00% | 90.00% |
| Comp-9 | S-F | 3.17% | 96.83% |
| Comp-10 | S-G | 3.00% | 97.00% |
| Comp-11 | S-G | 1.51% | 98.49% |
| Comp-12 | S-H | 1.23% | 98.77% |
| Comp-13 | S-I | 2.87% | 97.13% |
| Comp-14 | S-J | 4.30% | 95.70% |
| Comp-15 | S-K | 8.60% | 91.40% |
| Comp-16 | PG-C, | 20% PG-C, | 79.25% |
| | S-G | 0.75% S-G | |
| Comp-17 | PG-C, | 20% PG-C, | 79.39% |
| | S-H | 0.614% S-H | |
| Comp-18 | PG-C, | 15.85% PG-C, | 83.16% |
| | TEA | 1.00% TEA | |
| | (Triethanolamine) | | |
| Comp-21 | PG-C, | 15.87% PG-C, | 83.30% |
| | S-I | 0.83% S-I | |
| Comp-22 | S-H | 0.61% | 99.39% |

### Example 4: Diaphragm Pump Test for Polymer Composition Shear Stability Evaluation

The results of the diaphragm pump test are listed in Table 5.

Based on a 3-day diaphragm pump shear stability study, oil-in-water emulsions with additives comprising polyglycerol and/or sulfur-containing surfactants showed dramatically reduced gel formation in the diaphragm pump and had no or minimum flow rate reduction after the 3-day test. The additives had no negative impact on the product bulk viscosity (BV), see Table 5.

Tests on Table 5 were conducted with 1600 g of each polymer composition, freshly filtered through a 100-mesh filter. A baseline test (Entry 1) was conducted with the neat polymer Comp-1.

For tests on oil-in-water emulsion compositions with additive(s), the intended additive(s) was added to the polymer composition while agitating with a cage stirrer at 700 to 800 RPM. After 30 minutes agitation at 700 to 800 RPM, the polymer composition was measured for its bulk viscosity (BV) using a Brookfield viscometer and spindle No. 1 at 30 RPM, and then filtering through a 100-mesh filter into a half gallon jug for testing.

The diaphragm pump tests results shown in Table 5 were performed using standard 0.5 inch tubing for the pump's inlet and outlet plumbing. The inlet and outlet tubes were merged into the testing solution through holes on the cap of the testing vessel, but did not touch the bottom of the testing vessel. The pump was firmly clamped on a lab bench or cart. The diaphragm pump speed was set at 80% of maximum and the stroke was set to maximum. The test was run for 3 days (72 hours) at room temperature (20-22° C.). After 30 minutes of the test, the initial flow rate (FR, mL/minute) was measured using a 25-mL graduated cylinder and a timer. After the 3-day test, the flow rate was measured again as the final FR for flow rate reduction evaluation. Then, the test assembly was taken down and the BV was measured.

After the test, the tubings were removed from the pump, and DI water was run through the pump from top to bottom to clean any polymer emulsion left in the pump. The pump's head was taken apart, all gel in the pump was collected on a 100-mesh filter and rinsed with DI water. The collected gel from the pump was dried on a paper towel in a hood overnight and the gel was weighed in grams. The gel reduction % for tests with additives was calculated relative to the gel in pump of the neat oil-in-water emulsion (Comp-1) test (Entry 1).

TABLE 5
Product shear stability test results by diaphragm pump test

| | | | % of | | | | | | | | |
|---|---|---|---|---|---|---|---|---|---|---|---|
| | | | Additive(s) | % of Comp- | | | | Gel | % Gel | | |
| | | | in | 1 in | | | | in | reduction | Initial | Final |
| | Composition | | composition | composition | Initial FR | Final FR | % FR | pump | compared | BV | BV |
| Entry | ID | Additives | (wt. %) | (wt. %) | (mL/minute) | (mL/minute) | reduction | (g) | to Entry 1 | (cP) | (cP) |
| 1 | Comp-1 | — | — | 100% | 25.64 | 5.36 | 79.10% | 4.337 | — | 10.8 | 10.2 |
| 2 | Comp-2 | Commercial | 8.00% | 92.00% | 24.94 | — | Pump failed in less than 2 | | | 12.4 | 12 |
| | | glycerol | | | | | days due to gel | | | | |
| | | | | | | | accumulation. | | | | |
| 3 | Comp-3 | PG-A | 16.00% | 84.00% | 52.9 | 36.04 | 31.87% | 1.127 | 74.01% | 9.2 | 9.6 |
| 4 | Comp-4 | PG-B | 16.00% | 84.00% | 53.15 | 51.26 | 3.55% | 0.277 | 93.61% | 9 | 10 |
| 5 | Comp-5 | PG-C | 8.00% | 92.00% | 28.15 | 27.87 | 1.01% | 0.494 | 88.61% | 10 | 10.3 |
| 6 | Comp-6 | PG-C | 16.00% | 84.00% | 27.34 | 27.35 | −0.03% | 0.063 | 98.55% | 10.2 | 10 |
| 7 | Comp-7 | PG-D | 16.00% | 84.00% | 32.0 | 33.2 | −3.76% | 0.23 | 94.70% | — | 30.8 |
| 8 | Comp-8 | PG-E | 10.00% | 90.00% | 28.12 | 27.31 | 2.89% | 0.377 | 91.31% | 22 | 21.2 |
| 9 | Comp-9 | S-F | 3.17% | 96.83% | 40.87 | 42.06 | −2.92% | 0.478 | 88.98% | 13.4 | 13 |
| 10 | Comp-10 | S-G | 3.00% | 97.00% | 32.6 | 31.91 | 2.12% | 0.181 | 95.83% | 14.6 | 13.4 |
| 11 | Comp-11 | S-G | 1.51% | 98.49% | 48.37 | 30.72 | 36.49% | 0.787 | 81.85% | 26.8 | 27 |
| 12 | Comp-12 | S-H | 1.23% | 98.77% | 54.03 | 50.32 | 6.87% | 0.101 | 97.67% | 52 | 51 |
| 13 | Comp-13 | S-I | 2.87% | 97.13% | 34.93 | 25.58 | 26.76% | 1.389 | 67.97% | 13 | 13 |
| 14 | Comp-14 | S-J | 4.30% | 95.70% | 47.35 | 35.97 | 24.03% | 1.485 | 65.75% | 10.8 | 10.4 |
| 15 | Comp-15 | S-K | 8.60% | 91.40% | 35.76 | 22.76 | 36.37% | 0.891 | 79.45% | 10 | 9.8 |
| 16 | Comp-16 | PG-C, | 20% PG-C, | 79.25% | 38.11 | 42.87 | −12.50% | 0.239 | 94.49% | 8 | 8.2 |
| | | S-G | 0.75% S-G | | | | | | | | |
| 17 | Comp-17 | PG-C, | 20% PG-C, | 79.39% | 42.5 | 44.37 | −4.38% | 0.032 | 99.26% | 10 | 25 |
| | | S-H | 0.614% S- | | | | | | | | |
| | | | H | | | | | | | | |

Note:
Negative %FR reduction indicated improvement in pump flow rate.

### Example 5: Polymer Composition Drag Reduction (DR) Measured by Flow Loop Test

Effectiveness of the polymer compositions in reducing pressure loss in a fluid conduit was evaluated using a flow loop of stainless-steel pipe (0.834-inch ID). The flow loop contained a low shear, variable speed pump, a mass flow meter to control flow rate, a chiller to maintain a constant temperature, and a chemical injection pump to inject the polymer compositions. All flow loop tests were performed with 60 ppm polymer in kerosene circulated through the loop at a fixed flow rate of 40 KG/minute and at a test temperature of 60° C. A differential pressure transducer was used to monitor pressure drop along a 7-foot long test section. Drag reduction along the test section was calculated as follows:

$$\% Drag reduction = \frac{{P}_{0} - {P}_{t}}{{P}_{0}}$$

where:
% Drag reduction (DR)=% pressure loss reduction
P₀=pressure loss before chemical was injected and
Pₜ=pressure loss at time t after chemical was injected.

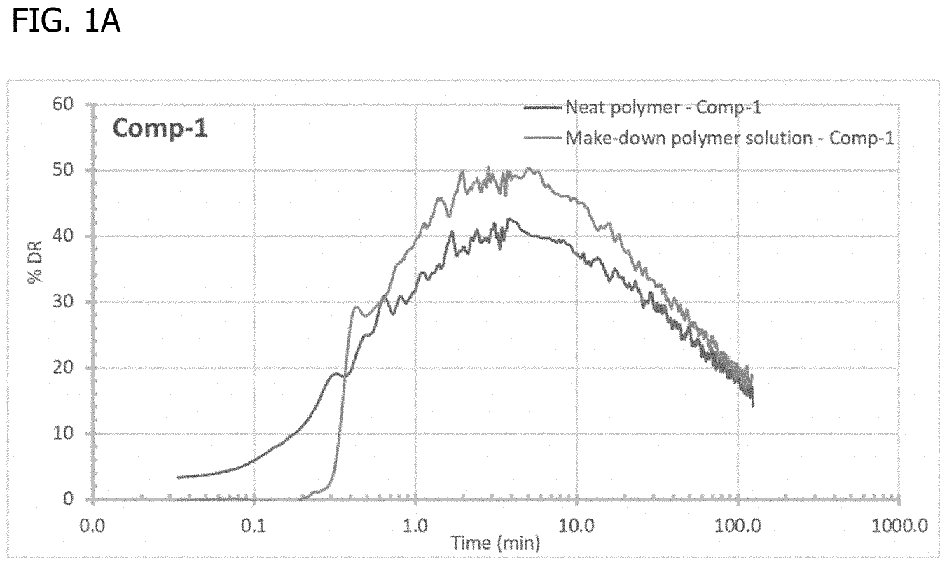

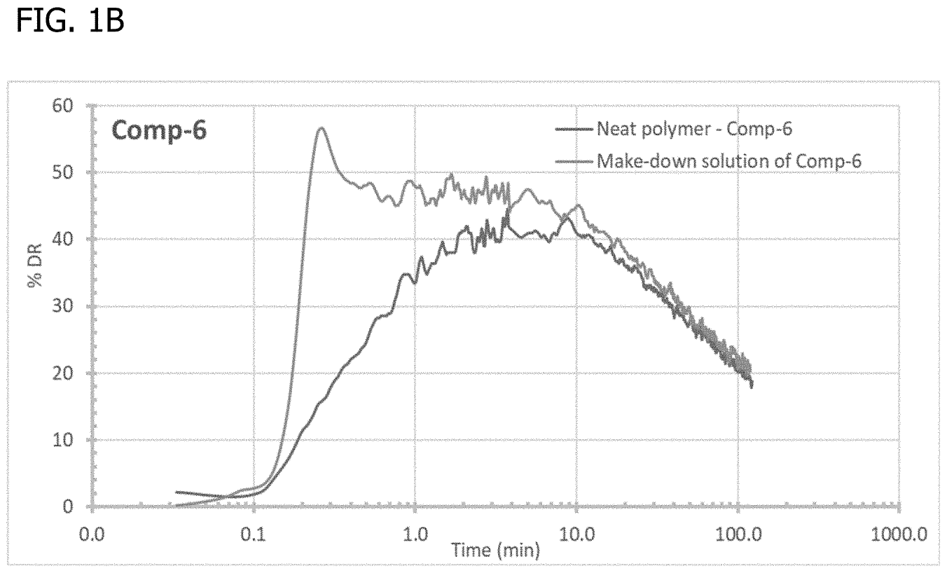

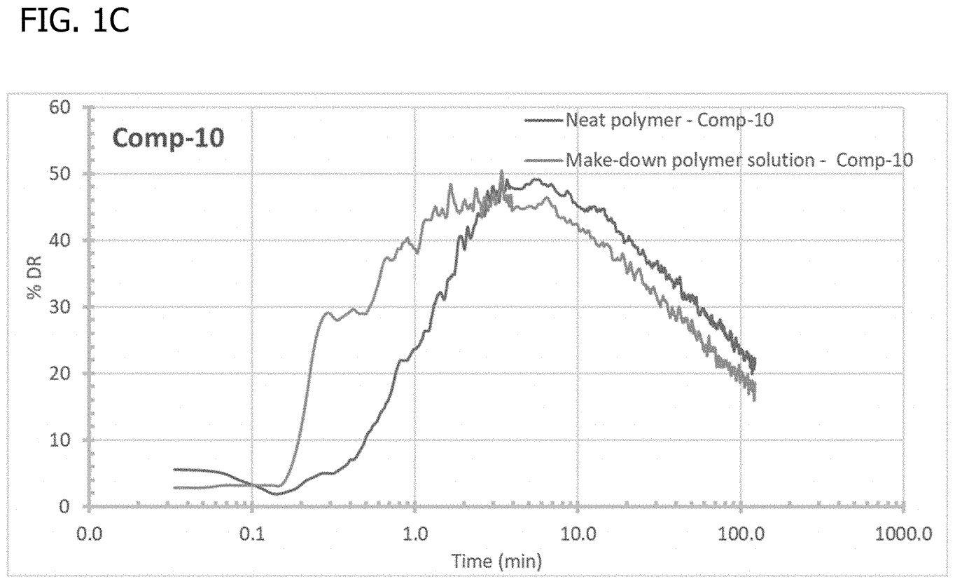

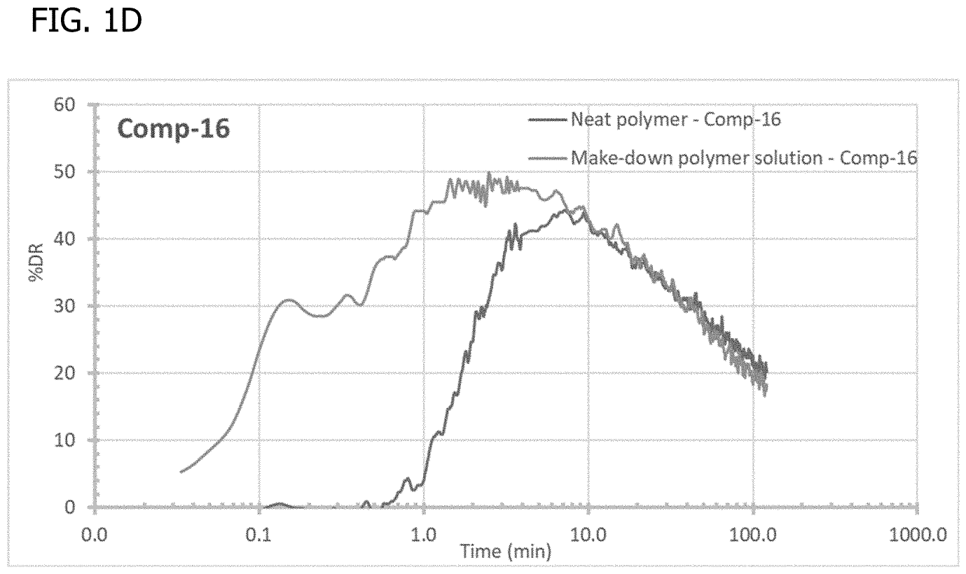

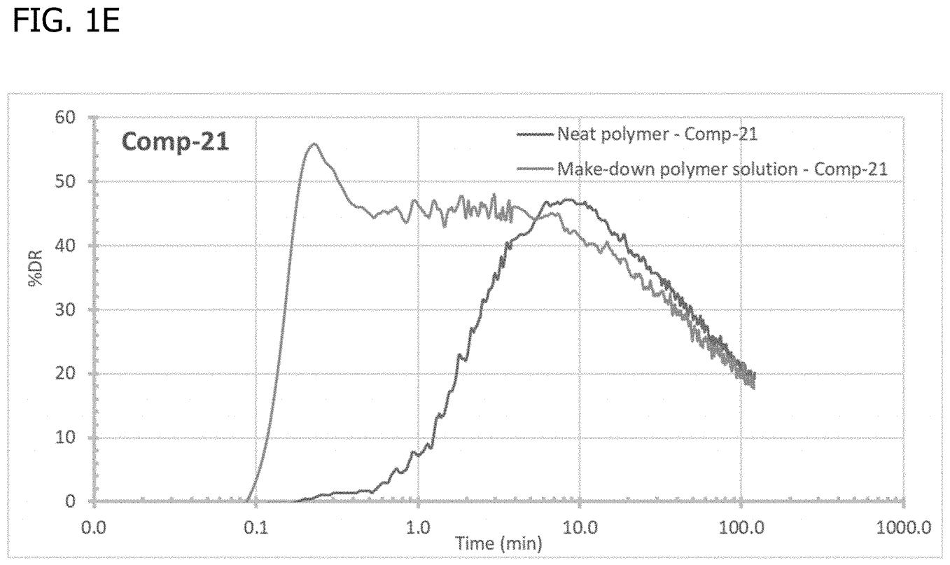

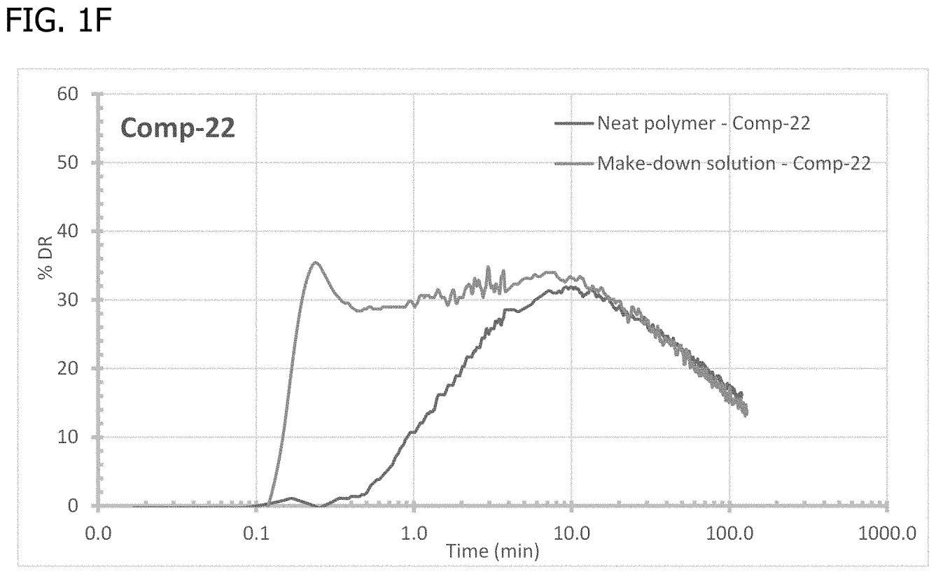

The flow loop test indicated that polymer compositions comprising polyglycerol and/or sulfur-containing surfactants were self-invertible and performed equally as good as the original oil-in-water emulsions, see FIG. 1.

### Example 6: High Pressure Pump Test Using a Dynamic Stability Umbilical Loop

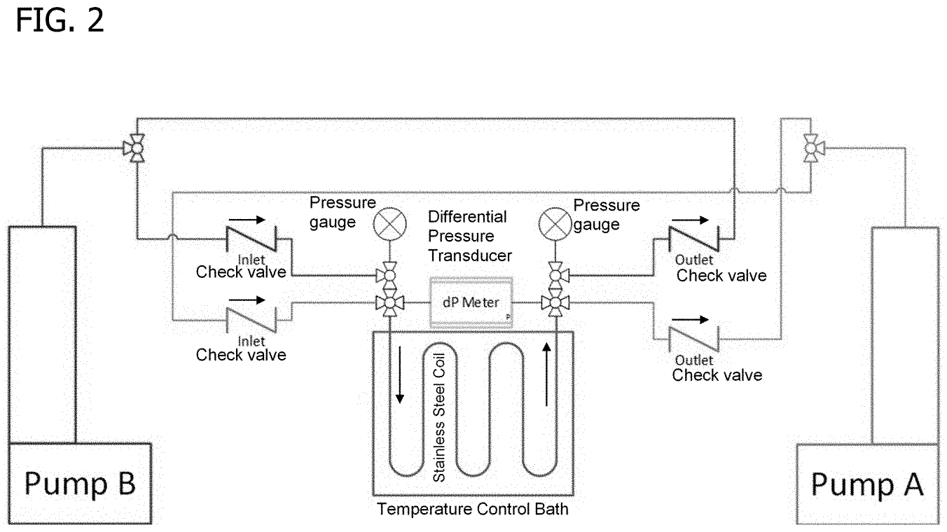

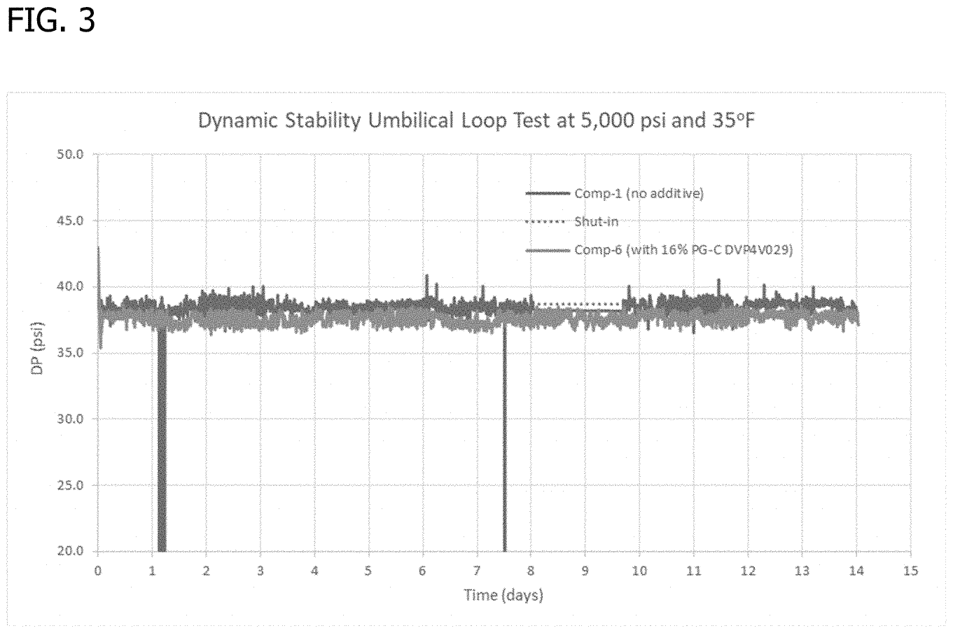

A dynamic stability umbilical loop (DSUL) was used to evaluate product stability under dynamic conditions (FIG. 2). The polymer composition was recirculated between two ISCO pumps, Pump A and Pump B, at a constant flow rate of 5 mL/minute through a stainless-steel coil for 14 days. The coil had a ⅛-inch outside diameter (OD) and 50-foot length. The coil was immersed in a 35° F. (1.7° C.) water bath to simulate subsea umbilical conditions. A set of four check valves was arranged as shown in FIG. 2 so that the fluid only flows in one direction through the check valves and the coil. When Pump A pumped out the fluid to Pump B, Pump B was programmed to maintain a constant back pressure of 5,000 psi and vice versa. A differential pressure transducer was used to continuously record differential pressure (dP) between the inlet and outlet of the coil. An increase in differential pressure indicated solid build up in the coil. At the end of the 14-day test, the four check valves were disassembled, slightly rinsed with DI water and wiped with paper towel to dry. Solid deposits in the four check valves were then collected and weighted to evaluate solids/gel accumulated in the check valves during the test.

Two DSUL tests were run with Comp-1 (no additive) and Comp-6 (with 16% polyglycerol PG-C DVP4V029). No pressure buildup was observed for both tests but solids accumulated in check valves was reduced more than half for composition with polyglycerol (Comp-6), see Table 6. Average differential pressure of Comp-6 test was also lower.

TABLE 6
Solids accumulation and average differential pressure
from dynamic stability umbilical test

| | Solids from check | |
|---|---|---|
| | valves after 14 days | Average |
| Composition | (g) | dP (psi) |
| Comp-1 | 0.1986 | 38.5 |
| Comp-6 | 0.0891 | 37.6 |

### Example 7: Product Temperature Stability Test Results

The formulas with polyglycerol, sulfur-containing surfactant and triethanolamine (TEA) were tested for temperature stabilities, including seabed temperature tests at 35° F., cold (20° F.) and hot (140° F.) topside extreme storage temperatures tests, and cold (35° F.) stress centrifuge tests. Based on the test results, all formulas were stable under the static stability test conditions over the 14-day test duration, see Table 7. The compositions with polyglycerol and sulfur-containing surfactant passed the cold stress test up to two days and the composition with TEA (Comp-18) passed the test up to seven days.

TABLE 7
Product temperature stability test results

| | | | | Cold Stress Centrifuge Test at | |
|---|---|---|---|---|---|
| Composition | 14-day Static Stability Test | | | 35° F. and 2,000 rpm | |
| ID | 35° F. | 20° F. | 140° F. | After 2 days | After 7 days |
| Comp-6 | Liquid and no | Liquid and no | Liquid and no | Liquid and no | Liquid and |
| | phase | phase | phase | phase | phase |
| | separation | separation | separation | separation | separation |
| Comp-10 | Liquid and no | Liquid and no | Liquid and no | Liquid and no | Gel and |
| | phase | phase | phase | phase | phase |
| | separation | separation | separation | separation | separation |
| Comp-11 | Liquid and no | Liquid and no | Liquid and no | Liquid and no | Gel and |
| | phase | phase | phase | phase | phase |
| | separation | separation | separation | separation | separation |
| Comp-16 | Liquid and no | Liquid and no | Liquid and no | Liquid and no | Gel and |
| | phase | phase | phase | phase | phase |
| | separation | separation | separation | separation | separation |
| Comp-18 | Liquid and no | Liquid and no | Liquid and no | Liquid and no | Liquid and no |
| | phase | phase | phase | phase | phase |
| | separation | separation | separation | separation | separation |

A cold temperature test for product stability evaluation was performed where the compositions were tested at 20° F. (−6.67° C.) and 35° F. (1.67° C.) in refrigerators for 2 weeks.

An elevated temperature test for product stability evaluation was performed where the compositions were tested at 140° F. (60° C.) in an oven for two weeks.

A cold stress centrifuge test for product stability evaluation was performed where the compositions were tested in a centrifuge at 35° F. and 2000 RPM for 7 days. Visual observations were made and recorded after two days and seven days.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and methods without departing from the scope of the invention, it is intended that all matter contained in the above description and shown in the accompanying drawings shall be interpreted as illustrative and not in a limiting sense.

1. A polymer composition comprising:
an oil-in-water emulsion comprising an aqueous phase comprising water, and an oil phase comprising an oil-soluble polymer, an oil-miscible polymer, or an emulsifiable polymer, and
an additive,
wherein the additive comprises a polyglycerol, a polyglycerol derivative, a surfactant having a hydrophilic-lipophilic balance (HLB) of equal to or greater than about 8, or a combination thereof.

2. The polymer composition of claim 1, wherein the additive comprises a polyglycerol or a polyglycerol derivative, wherein the polyglycerol comprises a polyglycerol alkyl ether, a polyglycerol alkyl ester, or a combination thereof.

3. The polymer composition of claim 1, wherein the polyglycerol derivative comprises a linear alkyl group, a branched alkyl group, a linear alkenyl group, a branched alkenyl group, an anionic, a cationic, a zwitterionic derivative thereof, or a combination thereof.

4. The polymer composition of claim 4, wherein the polyglycerol or polyglycerol derivative comprises moieties having a linear structure, a branched structure, a hyperbranched structure, a dendritic structure, a cyclic structure, or a combination thereof.

5. The polymer composition of claim 2, wherein the polyglycerol or polyglycerol derivative has a weight average molecular weight of from about 150 Daltons to about 1,000,000 Daltons.

6. (canceled)

7. The polymer composition of claim 1, wherein the additive comprises the surfactant having a hydrophilic-lipophilic balance (HLB) of equal to or greater than about 8, and the surfactant having a hydrophilic-lipophilic balance (HLB) of equal to or greater than about 8 comprises a sulfur-containing surfactant.

8. The polymer composition of claim 7, wherein the sulfur-containing surfactant comprises an alkyl sulfate, an alkanol oxyalkylated sulfate, an alkylphenol oxyalkylated sulfate, an alkyl sulfonate, an alkanol oxyalkylated sulfonate, an alkylphenol oxyalkylated sulfonate, an alkyl sulfosuccinate, an alkanol oxyalkylated sulfosuccinate, an alkylphenol oxyalkylated sulfosuccinate, a sulfone, or a combination thereof.

9.-10. (canceled)

11. The polymer composition of claim 8, wherein the alkyl sulfate is a C₈ to C₁₈ alkyl sulfate.

12.-13. (canceled)

14. The polymer composition of claim 8, wherein the alkyl sulfosuccinate is a C₈ to C₁₈ alkyl sulfosuccinate.

15. The polymer composition of claim 1, further comprising a trialkyl amine, a trialkanol amine, a salt thereof, or a combination thereof.

16.-17. (canceled)

18. The polymer composition of claim 1, wherein the oil-soluble polymer, the oil-miscible polymer, or the emulsifiable polymer is derived from a monomer having a structure of Formula 1: 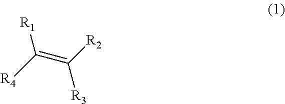
wherein
R₁, R₃, and R₄ are independently hydrogen, alkyl, alkenyl, or aryl;
R₂ is hydrogen, alkyl, alkenyl, aryl, —C(O)OR₅, or —C(O)NR₆R₇; and
R₅, R₆, and R₇ are independently hydrogen, alkyl, alkenyl, or aryl.

19. The polymer composition of claim 18, wherein the oil-soluble polymer, the oil-miscible polymer, or the emulsifiable polymer is derived from a monomer having a structure of Formula 2: 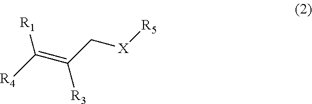
wherein
R₁, R₃, and R₄ are independently hydrogen, alkyl, alkenyl, or aryl;
X is —O— or —NR₆—;
R₅ is hydrogen, alkyl, alkenyl, or aryl; and
R₆ is hydrogen or alkyl.

20. The polymer composition of claim 19, wherein R₁, R₃, and R₄ are independently hydrogen or C₁ to C₆ alkyl.

21.-22. (canceled)

23. The polymer composition of claim 19, wherein X is —O—.

24. (canceled)

25. The polymer composition of claim 23, wherein R₅ is 2-ethylhexyl.

26.-29. (canceled)

30. The polymer composition of claim 18, wherein the oil-soluble polymer has a concentration of from about 10 wt. % to about 70 wt. % in the polymer composition, based on the amount of the oil-soluble polymer, additive, and water.

31. A method of reducing drag resistance in a hydrocarbon fluid flowing in a fluid conduit, the method comprising injecting the polymer composition of claim 1 into the conduit to contact the hydrocarbon fluid and thereby reduce the drag resistance of the hydrocarbon fluid in the conduit.

32. A method of delivering the polymer composition of claim 1 to a hydrocarbon fluid recovered from a hydrocarbon-containing subterranean formation comprising transporting the polymer composition through a fluid conduit having a length of at least about 500 feet, wherein the viscosity of the polymer composition is less than 500 centipoise in the fluid conduit and the oil-soluble polymer, the oil-miscible polymer, or the emulsifiable polymer begins being released from the emulsion within 30 minutes of contacting the hydrocarbon fluid.

33. (canceled)

34. A method of reducing the drag associated with transporting a hydrocarbon fluid through a subsea flowline comprising transporting the polymer composition of claim 1 through an umbilical line to the subsea flowline and contacting the polymer composition with the hydrocarbon fluid at an injection point.

35.-42. (canceled)

43. The method of claim 32, wherein the oil-in-water emulsion inverts to release the oil-soluble polymer, the oil-miscible polymer, or the emulsifiable polymer into the hydrocarbon fluid resulting in at least 25% drag reduction of the hydrocarbon fluid flowing in a conduit within 15 minutes after contacting the oil-in-water emulsion with the hydrocarbon fluid.

44.-46. (canceled)
